(19) United States
(12) Patent Application Publication
(10) Pub. No.: US 2025/0034329 A1
(43) Pub. Date: Jan. 30, 2025

(54) POLYESTER COMPOSITIONS COMPRISING CYCLOHEXANEDIMETHANOL OR 2,2,4,4-TETRAMETHYL-1,3-CYCLOBUTANEDIOL WITH IMPROVED CATALYST SYSTEMS THEREFOR

(71) Applicant: Eastman Chemical Company, Kingsport, TN (US)

(72) Inventors: Kate Elizabeth Allen, Jonesborough, TN (US); Brian Alan Schaefer, Kingsport, TN (US)

(73) Assignee: Eastman Chemical Company, Kingsport, TN (US)

(21) Appl. No.: 18/716,644

(22) PCT Filed: Dec. 7, 2022
(86) PCT No.: PCT/US2022/052084

§ 371 Date: Jun. 5, 2024

Related U.S. Application Data
(60) Provisional application No. 63/265,520, filed on Dec. 16, 2021.

(51) Int. Cl. C08G 63/199; C08G 63/83; C08G 63/84; C08G 63/85; C09D 167/02

(52) U.S. Cl. CPC C08G 63/199; C08G 63/83; C08G 63/84; C08G 63/85; C09D 167/02

(57) ABSTRACT

This invention relates to a polyester composition comprising: (1) at least one polyester which comprises: (a) a dicarboxylic acid component; (b) a glycol component; and (2) residues of a catalyst system comprising: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

### BACKGROUND OF THE INVENTION

Historically, tin (Sn) has been the preferred catalyst for producing thermoplastics and polyols. It is particularly effective for incorporating 2,2,4,4-tetramethyl-1,3-cyclobutanediol (TMCD) into polyesters/polyols. Tin based catalysts are typically the most efficient at incorporating TMCD into a polyester or polyol, However, tin based catalysts typically produce a yellow to amber colored copolyester in the presence of EG, e.g., Kelsey, U.S. Pat. No. 5,705,575; and Morris et al., U.S. Pat. No. 5,955,565. Also, there is a commercial need for use of non-tin catalysts in polyols for coating compositions. Alternative catalyst systems are needed in the art.

### BRIEF SUMMARY OF THE INVENTION

This invention relates to polyester compositions which can contain 1,4-cyclohexanedimethanol, and/or 2,2,4,4-tetramethyl-1,3-cyclobutanediol, and optionally modifying glycols, terephthalic acid, and isophthalic acid and novel catalyst systems and processes used to produce them. A distinct challenge has been found in effectiveness of transition metal catalysts for these polyesters/polyols in separating metal based esterification from the competing acid-catalyzed process at early reaction times. This invention is believed to have solved that challenge.

This invention relates to use of a catalyst system for making copolyesters can comprise 1,4-cyclohexanedimethanol, and/or 2,2,4,4-tetramethyl-1,3-cyclobutanediol, and optionally modifying glycols, terephthalic acid, and isophthalic acid which comprises: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

This invention relates to use of a catalyst system for making copolyesters or polyols can comprise 1,4-cyclohexanedimethanol, and/or 2,2,4,4-tetramethyl-1,3-cyclobutanediol, and optionally modifying glycols such as 2-methyl-1,3-propanediol (MPD), and trimethylolpropane (TMP), which comprises: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

This invention relates to use of a catalyst system for making copolyesters or polyols can comprise 1,4-cyclohexanedimethanol, and/or 2,2,4,4-tetramethyl-1,3-cyclobutanediol, and optionally modifying glycols such as hexanediol, which comprises: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

Several aspects are included in the invention, some of which are enumerated for clarification, and are not intended to limit this invention in any way.

In aspect 1, the invention relates to a polyester composition comprising:
(1) at least one polyester which comprises:
   (a) a dicarboxylic acid component comprising:
      (i) about 0.01 to about 50 mole % residues of terephthalic acid or esters thereof;
      (ii) about 50 to about 99.99 mole % residues of isophthalic acid or esters thereof;
      (iii) about 0 to about 30 mole % of aromatic or aliphatic dicarboxylic acid residues, or combinations thereof, having up to 20 carbon atoms;
   (b) a glycol component comprising:
      (i) about 25 to about 65 mole % of 1,4-cyclohexanedimethanol residues or 2,2,4,4-tetramethyl-1,3-cyclobutanediol residues; and
      (ii) about 35 to about 75 mole % of modifying glycol residues;
wherein the total mole % of the dicarboxylic acid component is 100 mole %, and wherein the total mole % of the diol component is 100 mole %; and
(2) residues of a catalyst system comprising: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

In aspect 2, the invention relates to a polyester composition of aspect 1 wherein said modifying glycols can additionally comprise at least one of hexanediol, diethylene glycol, 1,2-propanediol, 1,3-propanediol, 2-methyl-1,3-propanediol, diethylene glycol, 1,4-butanediol, 1,5-pentanediol, p-xylene glycol, neopentyl glycol, isosorbide, polytetramethylene glycol, or combinations thereof.

In aspect 3, the invention relates to a polyester composition of aspects 1 or 2 wherein said modifying glycols can comprise 2-methyl-1,3-propanediol except for aspect 13 where it is already specified as being present and it therefore, not a modifying glycol.

In aspect 4, the invention relates to a polyester composition of aspects 1 or 2 wherein said modifying glycols can comprise hexanediol except for aspect 12 where it is already specified as being present and it therefore, not a modifying glycol.

In aspect 5, the invention relates to a polyester composition of any of aspects 1-4, wherein said modifying glycols can comprise ethylene glycol.

In aspect 6, the polyester composition of any of aspects 1-5 is provided, wherein said polyester can comprise 1,4-cyclohexanedimethanol residues in the amount of from about 25 to about 60 mole %, or from about 25 to about 55 mole %, or from about 25 to about 50 mole %, or from about 25 to about 45 mole %, or from about 25 to about 40 mole %, or from about 25 to about 35 mole %, or from about 30 to about 65 mole %, or from about 30 to about 60 mole %, or from about 30 to about 55 mole %, or from about 30 to about 50 mole %, or from about 30 to about 45 mole %, or from about 30 to about 40 mole %, or from about 30 to about 35 mole %, or from about 35 to about 65 mole %, or from about 35 to about 60 mole %, or from about 35 to about 55 mole %, or from about 35 to about 50 mole %, or from about 35 to about 45 mole %.

In aspect 7, the invention relates to a polyester composition of any of aspects 1-6, wherein said polyester can comprise residues of 2,2,4,4-tetramethyl-1,3-cyclobutanediol in the amount of from about 25 to about 60 mole %, or from about 25 to about 55 mole %, or from about 25 to about 50 mole %, or from about 25 to about 45 mole %, or from about 25 to about 40 mole %, or from about 25 to about 35 mole %, or from about 30 to about 65 mole %, or from about 30 to about 60 mole %, or from about 30 to about 55 mole %, or from about 30 to about 50 mole %, or from about 30 to about 45 mole %, or from about 30 to about 40 mole %, or from about 30 to about 35 mole %, or from about 35 to about 65 mole %, or from about 35 to about 60 mole %, or from about 35 to about 55 mole %, or from about 35 to about 50 mole %, or from about 35 to about 45 mole %.

In aspect 8, the invention relates to a polyester composition of any of aspects 1-7, wherein the polyester can comprise less than 55 mole %, or less than 50 mole %, or less than 40 mole %, or less than 35 mole %, or less than 30 mole %, or less than 25 mole %, or less than 20 mole %, or less than 15 mole %, or less than 10 mole %, or 0 mole % of ethylene glycol residues, based on the total mole percentages of glycol residues in the final polyester equaling 100 mole %.

In aspect 9, the invention relates to a polyester composition of any of aspects 1-8, wherein the polyester can comprise less than 55 mole %, or less than 50 mole %, or less than 40 mole %, or less than 35 mole %, or less than 30 mole %, or less than 25 mole %, or less than 20 mole %, or less than 15 mole %, or less than 10 mole %, or 0 mole % of neopentyl glycol residues, based on the total mole percentages of glycol residues in the final polyester equaling 100 mole %.

In aspect 10, the invention relates to a polyester composition of any of aspects 1-9, wherein the polyester can comprise less than 55 mole %, or less than 50 mole %, or less than 40 mole %, or less than 35 mole %, or less than 30 mole %, or less than 25 mole %, or less than 20 mole %, or less than 15 mole %, or less than 10 mole %, or 0 mole % of cyclohexanedicarboxylic acid residues, based on the total mole percentages of acid residues in the final polyester equaling 100 mole %.

In aspect 11, the invention relates to a polyester composition of any of aspects 1-10, wherein the polyester can comprise residues of 2,2,4,4-tetramethyl-1,3-cyclobutanediol to 1,4-cyclohexanedimethanol in molar ratios of 1:3 to 3:1, or from 1:2 to 2:1, or from 1:1.5 to 1.5:1, or from 1:1.25 to 1.25:1.

In aspect 12, the invention relates to a polyester composition of any of aspects 1-11 comprising:
(1) at least one polyester which can comprise:
   (a) a dicarboxylic acid component comprising:
      (i) about 5 to about 40 mole %, or about 10 to 35 mole % residues of terephthalic acid or esters thereof;
      (ii) about 60 to about 95 mole %, or about 65 to about 90 mole % residues of isophthalic acid or esters thereof;
      (iii) about 0 to about 25 mole % of aromatic or aliphatic dicarboxylic acid residues, or combinations thereof, having up to 20 carbon atoms;
   (b) a glycol component comprising:
      (i) about 25 to about 65 mole % each of 1,4-cyclohexanedimethanol residues and/or 2,2,4,4-tetramethyl-1,3-cyclobutanediol residues; wherein the total mole percentage of both glycols cannot exceed 95 mole %;
      (ii) about 5 to about 25 mole % of hexanediol residues; and
      (iii) about 0 to about 70 mole % of modifying glycol residues;
wherein the total mole % of the dicarboxylic acid component is 100 mole %, wherein the total mole % of the diol component is 100 mole %; and
(2) residues of a catalyst system comprising: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

In aspect 13, the invention relates to a polyester composition of any of aspects 1-11 comprising:
(1) at least one polyester which can comprise:
   (a) a dicarboxylic acid component comprising:
      (i) about 5 to about 40 mole %, or about 10 to about 35 mole % residues of terephthalic acid or esters thereof;
      (ii) about 60 to about 95 mole %, or about 65 to about 90 mole %, or about 70 to about 90 mole % residues of isophthalic acid or esters thereof;
      (iii) about 0 to about 25 mole % of aromatic or aliphatic dicarboxylic acid residues, or combinations thereof, having up to 20 carbon atoms;
   (b) a glycol component comprising:
      (i) about 35 to about 50 mole % each of 1,4-cyclohexanedimethanol residues and/or 2,2,4,4-tetramethyl-1,3-cyclobutanediol residues, wherein the total mole percentages of the combinations of both glycols cannot exceed 94.5 mole %;
      (ii) about 5 to about 20 mole % of 2-methyl-1,3-propanediol residues; and
      (iii) optionally, about 0.5 to about 5 mole % of trimethylolpropane residues;
      (iv) about 0 to about 69.5 mole % of modifying glycol residues;
   wherein the total mole % of the dicarboxylic acid component is 100 mole %,
   wherein the total mole % of the diol component is 100 mole %; and
(2) residues of a catalyst system comprising: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

In aspect 14, the invention relates to a polyester composition of any of aspects 1-13, wherein the polyester can comprise residues of 2,2,4,4-tetramethyl-1,3-cyclobutanediol to hexanediol in molar ratios of 1:3 to 3:1, or from 1:2 to 2:1, or from 2.5:0.5 to 0.5:2.5, or from 2.5:0.5, or from 2:1.

In aspect 15, the invention relates to a polyester composition of any of aspects 1-14, wherein the polyester can comprise residues of 1,4-cyclohexanedimethanol to residues of hexanediol in molar ratios of 1:3 to 3:1, or from 1:2 to 2:1, or from 2.5:0.5 to 0.5:2.5, or from 2.5:0.5, or from 2:1.

In aspect 16, the invention relates to a polyester composition of any one of aspects 1-15, wherein the polyester can comprise residues of a diacid component comprising aromatic or aliphatic dicarboxylic acid ester residues, or combinations thereof.

In aspect 17, the invention relates to a polyester composition of any one of aspects 1-16, wherein the polyester can comprise residues of a dicarboxylic acid component comprising:
(i) about 0.01 to about 50 mole % residues of terephthalic acid or esters thereof; and
(ii) about 50 to about 99.99 mole % residues of isophthalic acid or esters thereof.

In aspect 18, the invention relates to a polyester composition of any one of aspects 1-17, wherein the polyester comprises residues of a dicarboxylic acid component comprising:
(i) about 5 to about 40 mole %, or about 10 to about 35 mole % residues of terephthalic acid or esters thereof; and
(ii) about 60 to about 95 mole %, or about 65 to about 90 mole %, or about 70 to about 90 mole % residues of isophthalic acid or esters thereof.

In aspect 19, the invention relates to a polyester composition of any of aspects 1-18, wherein the polyester comprises residues of terephthalic acid to isophthalic acid in molar ratios of from 1:10 to 10:1, or from 1:9 to 9:1, or from 1:8 to 8:1, or from 1:7 to 7:1, or from 1:6 to 6:1, or from 1:5 to 5:1, or from 1:4 to 4:1, or from 1:5 to 5:1, or from 1:3 to 3:1, or from 1:2 to 2:1, or from 1:10 to 1:2, or from 1:9 to 1:2, or 1:9, or 1:8, or 1:7, or 1:6, or 1:5, 1:4, or 1:3, or 1:2.

In aspect 20, the invention relates to a polyester composition of any one of aspects 1-19, wherein the 2,2,4,4-tetramethyl-1,3-cyclobutanediol residues are a combination which can comprise greater than 50 mole % of cis-2,2,4,4-tetramethyl-1,3-cyclobutanediol and less than 50 mole % of trans-2,2,4,4-tetramethyl-1,3-cyclobutanediol, or greater than 70 mole % of cis-2,2,4,4-tetramethyl-1,3-cyclobutanediol and less than 30 mole % of trans-2,2,4,4-tetramethyl-1,3-cyclobutanediol, or greater than 75 mole % of cis-2,2,4,4-tetramethyl-1,3-cyclobutanediol and less than 25 mole % of trans-2,2,4,4-tetramethyl-1,3-cyclobutanediol, or greater than 80 mole % of cis-2,2,4,4-tetramethyl-1,3-cyclobutanediol and less than 20 mole % of trans-2,2,4,4-tetramethyl-1,3-cyclobutanediol, or greater than 85 mole % of cis-2,2,4,4-tetramethyl-1,3-cyclobutanediol and less than 15 mole % of trans-2,2,4,4-tetramethyl-1,3-cyclobutanediol, or greater than 90 mole % of cis-2,2,4,4-tetramethyl-1,3-cyclobutanediol and less than 10 mole % of trans-2,2,4,4-tetramethyl-1,3-cyclobutanediol, or greater than 95 mole % of cis-2,2,4,4-tetramethyl-1,3-cyclobutanediol and less than 5 mole % of trans-2,2,4,4-tetramethyl-1,3-cyclobutanediol.

In aspect 21, the invention relates to a polyester composition of any of aspects 1-20, wherein the inherent viscosity can be from 0.10 to 0.70 dL/g, or from 0.10 to 0.65 dL/g, or from 0.10 to 0.60 dL/g, or from 0.10 to 0.55 dL/g, or from 0.10 to 0.50 dL/g, or from 0.10 to 0.45 dL/g, or from 0.15 to 0.40 dL/g, or from 0.10 to 0.35 dL/g, or from 0.20 to 0.30 dL/g, or from 0.15 to 0.70 dL/g, or from 0.15 to 0.65 dL/g, or from 0.15 to 0.60 dL/g, or from 0.15 to 0.55 dL/g, or from 0.15 to 0.50 dL/g, from 0.15 to 0.45 dL/g, or from 0.20 to 0.40 dL/g, or from 0.15 to 0.35 dL/g, from 0.15 to 0.30 dL/g, 0.20 to 0.50 dL/g, or from 0.20 to 0.45 dL/g, or from 0.15 to 0.40 dL/g, or from 0.20 to 0.35 dL/g, or from 0.20 to 0.30 dL/g, or from 0.20 to 0.29 dL/g, or from 0.20 to 0.28 dL/g, or from 0.22 to 0.26 dL/g, or from or from 0.25 to 0.50 dL/g, from 0.25 to 0.45 dL/g, or from 0.25 to 0.40 dL/g, or from 0.20 to 0.35 dL/g, or from 0.25 to 0.30 dL/g, or at least 0.10 dL/g, or at least 0.15 dL/g, or at least 0.2 dL/g, as determined in 60/40 (wt/wt) phenol/tetrachloroethane at a concentration of 0.5 g/100 ml at 25° C.

In aspect 22, the invention relates to a polyester composition of any of aspects 1-21, wherein the number average molecular weight can be from 2000 to 8000, or from 2000 to 7500, or from 2000 to 7000, or from 2000 to 6500, or from 2000 to 6000, or from 2000 to 5500, or from 2000 to 5000, or from 2500 to 8000, or from 2500 to 7500, or from 2500 to 7000, or from 2500 to 6500, or from 2500 to 6000, or from 2500 to 5500, or from 2500 to 5000, from 3000 to 8000, or from 3000 to 7500, or from 3000 to 7000, or from 3000 to 6500, or from 3000 to 6000, or from 3000 to 5500, or from 3000 to 5000, from 4000 to 8000, or from 4000 to 7500, or from 4000 to 7000, or from 4000 to 6500, or from 4000 to 6000, or from 4000 to 5500, or from 4000 to 5000, or from 4500 to 5000.

In aspect 23, the invention relates to a polyester composition of any one of aspects 1-22, which can comprise lithium atoms and aluminum atoms.

In aspect 24, the invention relates to a polyester composition of aspect 23, wherein lithium atoms can be present in the amount of from 5 to 300 ppm, or from 5 to 250 ppm, or from 5 to 200 ppm, or from 5 to 150 ppm, or from 5 to 140 ppm, or from 5 to 130 ppm, or from 5 to 120 ppm, or from 5 to 115 ppm, or from 5 to 110 ppm, or from 10 to 300 ppm, or from 10 to 250 ppm or from 10 to 200 ppm, or from 10 to 150 ppm, or from 10 to 140 ppm, or from 10 to 130 ppm, or from 10 to 120 ppm, or from 10 to 115 ppm, or from 10 to 110 ppm, or from 15 to 300 ppm, or from 15 to 250 ppm, or from 15 to 200 ppm, or from 15 to 150 ppm, or from 15 to 140 ppm, or from 15 to 130 ppm, or from 15 to 120 ppm, or from 15 to 115 ppm, or from 15 to 110 ppm, or from 20 to 300 ppm, or from 20 to 250 ppm, or from 20 to 200 ppm, or from 20 to 150 ppm, or from 20 to 140 ppm, or from 20 to 130 ppm, or from 20 to 120 ppm, or from 20 to 115 ppm, or from 20 to 110 ppm, or from 25 to 300 ppm, or from 25 to 250 ppm, or from 25 to 200 ppm, or from 25 to 150 ppm, or from 25 to 140 ppm, or from 25 to 130 ppm, or from 25 to 120 ppm, or from 25 to 115 ppm, or from 25 to 110 ppm, or from 30 to 300 ppm, or from 30 to 250 ppm, or from 30 to 200 ppm, or from 30 to 150 ppm, or from 30 to 140 ppm, or from 30 to 130 ppm, or from 30 to 120 ppm, or from 30 to 115 ppm, or from 30 to 110 ppm, or from 35 to 300 ppm, or from 35 to 250 ppm, or from 35 to 200 ppm, or from 35 to 150 ppm, or from 35 to 110 ppm, or from 40 to 300 ppm, or from 40 to 250 ppm, or from 40 to 200 ppm, or from 40 to 150 ppm, or from 40 to 140 ppm, or from 40 to 130 ppm, or from 40 to 120 ppm, or from 40 to 115 ppm, or from 40 to 110 ppm, relative to the mass of final polyester being prepared.

In aspect 25, the invention relates to a polyester composition of aspect 24, wherein lithium atoms can be present in the amount of from 20 to 150 ppm, or from 20 to 140 ppm, or from 20 to 130 ppm, or from 20 to 120 ppm, or from 20 to 115 ppm, or from 20 to 110 ppm, or from 20 to 105 ppm, or from 20 to 100 ppm, or from 20 to 95 ppm, or from 20 to 90 ppm, or from 20 to 85 ppm, or from 20 to 80 ppm, or from 25 to 150 ppm, or from 25 to 140 ppm, or from 25 to 130 ppm, or from 25 to 120 ppm, or from 25 to 115 ppm, or from 25 to 110 ppm, or from 25 to 105 ppm, or from 25 to 100 ppm, or from 25 to 95 ppm, or from 25 to 90 ppm, or from 25 to 85 ppm, or from 25 to 80 ppm, or from 30 to 150 ppm, or from 30 to 140 ppm, or from 30 to 130 ppm, or from 30 to 120 ppm, or from 30 to 115 ppm, or from 30 to 110 ppm, or from 30 to 105 ppm, or from 30 to 100 ppm, or from 30 to 95 ppm, or from 30 to 90 ppm, or from 30 to 85 ppm, or from 30 to 80 ppm, or from 35 to 150 ppm, or from 35 to 110 ppm, relative to the mass of final polyester being prepared.

In aspect 26, the invention relates to a polyester composition of any one of aspects 1-25, wherein aluminum atoms can be present in the amount of from 5 to 300 ppm, or from 5 to 275 ppm, or from 5 to 250 ppm, or from 5 to 200 ppm, or from 5 to 150 ppm, or from 5 to 140 ppm, or from 5 to 135 ppm, or from 5 to 130 ppm, or from 5 to 120 ppm, or from 5 to 115 ppm, or from 5 to 110 ppm, or from 10 to 300 ppm, or from 10 to 275 ppm, or from 10 to 250 ppm or from 10 to 200 ppm, or from 10 to 175 ppm, or from 10 to 150 ppm, or from 10 to 140 ppm, or from 10 to 135 ppm, or from 10 to 130 ppm, or from 10 to 120 ppm, or from 10 to 115 ppm, or from 10 to 110 ppm, or from 15 to 300 ppm, or from 15 to 275 ppm, or from 15 to 250 ppm, or from 15 to 200 ppm, or from 15 to 175 ppm, or from 15 to 150 ppm, or from 15 to 140 ppm, or from 15 to 130 ppm, or from 15 to 135 ppm, or from 15 to 120 ppm, or from 15 to 115 ppm, or from 15 to 110 ppm, or from 20 to 300 ppm, or from 20 to 275 ppm, or from 20 to 250 ppm, or from 20 to 200 ppm, or from 20 to 175 ppm, or from 20 to 150 ppm, or from 20 to 140 ppm, or from 20 to 135 ppm, or from 20 to 130 ppm, or from 20 to 120 ppm, or from 20 to 115 ppm, or from 20 to 110 ppm, or from 25 to 300 ppm, or from 25 to 275 ppm, or from 25 to 250 ppm, or from 25 to 200 ppm, or from 25 to 175 ppm, or from 25 to 150 ppm, or from 25 to 140 ppm, or from 25 to 135 ppm, or from 25 to 130 ppm, or from 25 to 120 ppm, or from 25 to 115 ppm, or from 25 to 110 ppm, or from 30 to 300 ppm, or from 30 to 275 ppm, or from 30 to 250 ppm, or from 30 to 200 ppm, or from 30 to 150 ppm, or from 30 to 140 ppm, or from 30 to 135 ppm, or from 30 to 130 ppm, or from 30 to 120 ppm, or from 30 to 115 ppm, or from 30 to 110 ppm, or from 35 to 300 ppm, or from 35 to 275 ppm, or from 35 to 250 ppm, or from 35 to 200 ppm, or from 35 to 150 ppm, or from 35 to 140 ppm, or from 35 to 135 ppm, or from 35 to 130 ppm, or from 35 to 120 ppm, or from 35 to 115 ppm, or from 35 to 110 ppm, or from 40 to 300 ppm, or from 40 to 275 ppm, or from 40 to 250 ppm, or from 40 to 200 ppm, or from 40 to 150 ppm, or from 40 to 140 ppm, or from 40 to 135 ppm, or from 40 to 130 ppm, or from 40 to 120 ppm, or from 40 to 115 ppm, or from 40 to 110 ppm, relative to the mass of final polyester being prepared.

In aspect 27, the invention relates to a polyester composition of any one of aspects 1-26, wherein aluminum atoms can be present in the amount of from 5 to 300 ppm, or from 5 to 275 ppm, or from 5 to 250 ppm, or from 5 to 200 ppm, or from 5 to 150 ppm, or from 5 to 140 ppm, or from 5 to 135 ppm, or from 5 to 130 ppm, or from 5 to 120 ppm, or from 5 to 115 ppm, or from 5 to 110 ppm, or from 10 to 300 ppm, or from 10 to 275 ppm, or from 10 to 250 ppm or from 10 to 200 ppm, or from 10 to 175 ppm, or from 10 to 150 ppm, or from 10 to 140 ppm, or from 10 to 135 ppm, or from 10 to 130 ppm, or from 10 to 120 ppm, or from 10 to 115 ppm, or from 10 to 110 ppm, or from 15 to 300 ppm, or from 15 to 275 ppm, or from 15 to 250 ppm, or from 15 to 200 ppm, or from 15 to 175 ppm, or from 15 to 150 ppm, or from 15 to 140 ppm, or from 15 to 130 ppm, or from 15 to 135 ppm, or from 15 to 120 ppm, or from 15 to 115 ppm, or from 15 to 110 ppm, or from 20 to 300 ppm, or from 20 to 275 ppm, or from 20 to 250 ppm, or from 20 to 200 ppm, or from 20 to 175 ppm, or from 20 to 150 ppm, or from 20 to 140 ppm, or from 20 to 135 ppm, or from 20 to 130 ppm, or from 20 to 120 ppm, or from 20 to 115 ppm, or from 20 to 110 ppm, or from 30 to 300 ppm, or from 30 to 275 ppm, or from 30 to 250 ppm, or from 30 to 200 ppm, or from 30 to 175 ppm, or from 30 to 160 ppm, or from 30 to 155 ppm, or from 30 to 150 ppm, or from 30 to 140 ppm, or from 30 to 135 ppm, or from 30 to 130 ppm, or from 30 to 120 ppm, or from 30 to 115 ppm, or from 30 to 110 ppm, or from 40 to 300 ppm, or from 40 to 275 ppm, or from 40 to 250 ppm, or from 40 to 200 ppm, or from 40 to 175 ppm, or from 40 to 160 ppm, or from 40 to 155 ppm, or from 40 to 150 ppm, or from 40 to 140 ppm, or from 40 to 135 ppm, or from 40 to 130 ppm, or from 40 to 120 ppm, or from 40 to 115 ppm, or from 40 to 110 ppm, or from 50 to 300 ppm, or from 50 to 275 ppm, or from 50 to 250 ppm, or from 50 to 200 ppm, or from 50 to 175 ppm, or from 50 to 160 ppm, or from 50 to 155 ppm, or from 50 to 150 ppm, or from 50 to 140 ppm, or from 50 to 135 ppm, or from 50 to 130 ppm, or from 50 to 120 ppm, or from 50 to 115 ppm, or from 50 to 110 ppm, or from 60 to 300 ppm, or from 60 to 275 ppm, or from 60 to 250 ppm, or from 60 to 200 ppm, or from 60 to 175 ppm, or from 60 to 160 ppm, or from 60 to 155 ppm, or from 60 to 150 ppm, or from 60 to 140 ppm, or from 60 to 135 ppm, or from 60 to 130 ppm, or from 60 to 120 ppm, or from 60 to 115 ppm, or from 60 to 110 ppm, relative to the mass of final polyester being prepared.

In aspect 28, the invention relates to a polyester composition of any one of aspects 1-27, wherein the ratio of lithium atoms to aluminum atoms in ppm relative to the mass of final polyester being prepared can be from 1:5 to 5:1, or from 1:4 to 4:1, or from 1:3 to 3:1, or from 1:2 to 2:1, or from 1:4 to 1:0.25, or from 1:3 to 1:0.25, or from 1:1.25 to 1.0:0.25.

In aspect 29, the invention relates to a polyester composition of any one of aspects 1-28, wherein the total catalyst metal atoms in the polyester composition can be present in any of the amounts of from 10 to 600 ppm, 20 to 500 ppm, or from 10 to 400 ppm, or from 10 to 350 ppm, or from 10 to 300 ppm, or from 10 to 250 ppm, or from 20 to 600 ppm, 20 to 500 ppm, or from 20 to 400 ppm, or from 20 to 350 ppm, or from 20 to 300 ppm, or from 20 to 250 ppm, or 40 to 600 ppm, or 40 to 500 ppm, or from 40 to 400 ppm, or from 40 to 350, or from 40 to 300 ppm, or from 40 to 250 ppm, or from 50 to 600 ppm, or from 50 to 500 ppm, or from 50 to 400 ppm, or from 50 to 250 ppm, or from 60 to 600 ppm, or from 60 to 500 ppm, or from 60 to 400 ppm, or from 60 to 300 ppm, or from 60 to 250 ppm, or from 70 to 600 ppm, or from 70 to 500 ppm, or from 70 to 400 ppm, or from 70 to 350 ppm, or from 70 to 300 ppm, or from 70 to 250 ppm, or from 75 to 600 ppm, or from 70 to 500 ppm, or from 75 to 400 ppm, or from 75 to 350 ppm, or from 75 to 300 ppm, or from 75 to 250 ppm, or from 80 to 600 ppm, or from or from 80 to 500 ppm, or from 80 to 400 ppm, or from 80 to 350 ppm, or from 80 to 300 ppm, or from 80 to 250 ppm, or less than 600 ppm, or less than 500 ppm, or less than 400 ppm, or less than 350 ppm, or less than 300 ppm, or less than 250 ppm, relative to the mass of final polyester being prepared.

In aspect 30, the invention relates to a polyester composition of any one of aspects 1-22, which can comprise zirconium atoms.

In aspect 31, the invention relates to a polyester composition of aspect 30, wherein zirconium atoms can be present in the polyester composition in any of the amounts of from 5 to 600 ppm, or from 5 to 500 ppm, or from 5 to 400 ppm, or from or from 5 to 375 ppm, or from 5 to 350 ppm, or from 5 to 300 ppm, or from 5 to 250 ppm, or from 50 to 600 ppm, or from 50 to 500 ppm, or from 50 to 400 ppm, or from 50 to 375 ppm, or from 50 to 350 ppm, or from 50 to 300 ppm, or from 50 to 250 ppm, or from 50 to 200 ppm, or from 100 to 600 ppm, or from 100 to 500 ppm, or from 100 to 400 ppm, or from 100 to 375 ppm, or from 100 to 350 ppm, or from 100 to 300 ppm, or from 100 to 250 ppm, or from 100 to 200 ppm, or from 150 to 600 ppm, or from 150 to 500 ppm, or from 150 to 400 ppm, or from 150 to 375 ppm, or from 150 to 350 ppm, or from 150 to 300 ppm, or from 150 to 250 ppm, or from 200 to 600 ppm, or from 200 to 500 ppm, or from 200 to 400 ppm, or from 200 to 375 ppm, or from 200 to 350 ppm, relative to the mass of final polyester being prepared.

In aspect 32, the invention relates to a polyester composition of any one of aspects 1-31, which can comprise gallium atoms.

In aspect 33, the invention relates to a polyester composition of aspect 32, wherein gallium atoms can be present in the polyester composition any of the amount of from 5 to 300 ppm, or from 5 to 275 ppm, or from 5 to 250 ppm, or from 5 to 200 ppm, or from 5 to 150 ppm, or from 5 to 140 ppm, or from 5 to 135 ppm, or from 5 to 130 ppm, or from 5 to 120 ppm, or from 5 to 115 ppm, or from 5 to 110 ppm, or from 10 to 300 ppm, or from 10 to 275 ppm, or from 10 to 250 ppm or from 10 to 200 ppm, or from 10 to 175 ppm, or from 10 to 150 ppm, or from 10 to 140 ppm, or from 10 to 135 ppm, or from 10 to 130 ppm, or from 10 to 120 ppm, or from 10 to 115 ppm, or from 10 to 110 ppm, or from 15 to 300 ppm, or from 15 to 275 ppm, or from 15 to 250 ppm, or from 15 to 200 ppm, or from 15 to 175 ppm, or from 15 to 150 ppm, or from 15 to 140 ppm, or from 15 to 130 ppm, or from 15 to 135 ppm, or from 15 to 120 ppm, or from 15 to 115 ppm, or from 15 to 110 ppm, or from 20 to 300 ppm, or from 20 to 275 ppm, or from 20 to 250 ppm, or from 20 to 200 ppm, or from 20 to 175 ppm, or from 20 to 150 ppm, or from 20 to 140 ppm, or from 20 to 135 ppm, or from 20 to 130 ppm, or from 20 to 120 ppm, or from 20 to 115 ppm, or from 20 to 110 ppm, or from 30 to 300 ppm, or from 30 to 275 ppm, or from 30 to 250 ppm, or from 30 to 200 ppm, or from 30 to 175 ppm, or from 30 to 160 ppm, or from 30 to 155 ppm, or from 30 to 150 ppm, or from 30 to 140 ppm, or from 30 to 135 ppm, or from 30 to 130 ppm, or from 30 to 120 ppm, or from 30 to 115 ppm, or from 30 to 110 ppm, or from 40 to 300 ppm, or from 40 to 275 ppm, or from 40 to 250 ppm, or from 40 to 200 ppm, or from 40 to 175 ppm, or from 40 to 160 ppm, or from 40 to 155 ppm, or from 40 to 150 ppm, or from 40 to 140 ppm, or from 40 to 135 ppm, or from 40 to 130 ppm, or from 40 to 120 ppm, or from 40 to 115 ppm, or from 40 to 110 ppm, or from 50 to 300 ppm, or from 50 to 275 ppm, or from 50 to 250 ppm, or from 50 to 200 ppm, or from 50 to 175 ppm, or from 50 to 160 ppm, or from 50 to 155 ppm, or from 50 to 150 ppm, or from 50 to 140 ppm, or from 50 to 135 ppm, or from 50 to 130 ppm, or from 50 to 120 ppm, or from 50 to 115 ppm, or from 50 to 110 ppm, or from 60 to 300 ppm, or from 60 to 275 ppm, or from 60 to 250 ppm, or from 60 to 200 ppm, or from 60 to 175 ppm, or from 60 to 160 ppm, or from 60 to 155 ppm, or from 60 to 150 ppm, or from 60 to 140 ppm, or from 60 to 135 ppm, or from 60 to 130 ppm, or from 60 to 120 ppm, or from 60 to 115 ppm, or from 60 to 110 ppm, or from 100 to 600 ppm, or from 100 to 500 ppm, or from 100 to 400 ppm, or from 100 to 375 ppm, or from 100 to 350 ppm, or from 100 to 300 ppm, or from 100 to 250 ppm, or from 150 to 600 ppm, or from 150 to 500 ppm, or from 150 to 400 ppm, or from 150 to 375 ppm, or from 150 to 350 ppm, or from 150 to 300 ppm, or from 150 to 250 ppm, or from 200 to 600 ppm, or from 200 to 500 ppm, or from 200 to 400 ppm, or from 200 to 375 ppm, or from 200 to 350 ppm, or from 250 to 600 ppm, or from 250 to 500 ppm, or from 250 to 400 ppm, or from 250 to 375 ppm, or from 250 to 350 ppm, relative to the mass of final polyester being prepared.

In aspect 34, the invention relates to a polyester composition of any one of aspects 1-33, which can comprise titanium atoms in an amount of less than 30 ppm, or less than 20 ppm, or less than 10 ppm, or less than 5 ppm, or from 0 to 30 ppm, or from 0 to 20 ppm, or from 0 to 10 ppm, or 0 ppm, relative to the mass of final polyester being prepared.

In aspect 35, the invention relates to a polyester composition of any one of aspects 1-34, which can comprise tin atoms in an amount of less than 30 ppm, or less than 20 ppm, or less than 10 ppm, or less than 5 ppm, or from 0 to 30 ppm, or from 0 to 20 ppm, or from 0 to 10 ppm, or 0 ppm, relative to the mass of final polyester being prepared.

In aspect 36, the invention relates to a polyester composition of any one of aspects 1-35, which can comprise manganese atoms in an amount of less than 30 ppm, or less than 20 ppm, or less than 10 ppm, or less than 5 ppm, or from 0 to 30 ppm, or from 0 to 20 ppm, or from 0 to 10 ppm, or 0 ppm, relative to the mass of final polyester being prepared.

In aspect 37, the invention relates to a polyester composition of any one of aspects 1-36, which can comprise zinc atoms in an amount of less than 30 ppm, or less than 20 ppm, or less than 10 ppm, or less than 5 ppm, or from 0 to 30 ppm, or from 0 to 20 ppm, or from 0 to 10 ppm, or 0 ppm, relative to the mass of final polyester being prepared.

In aspect 38, the invention relates to a polyester composition of any one of aspects 1-37, which can have any of the b* values of from −10 to less than 20, −10 to less than 10, or from 1 to less than 20, or from 5 to less than 20, or from 8 to less than 20, or from −3 to 10, or from −5 to 5, or from −5 to 4, or from −5 to 3, or from 1 to 15, or from 1 to 14, or from 1 to 13, or from 1 to 12, or from 1 to 11, or from 1 to 10, or from 1 to 9, or from 1 to 8, from 1 to 7, or from 1 to 6, or from 1 to 5, or less than 20, or less than 15, or less than 10, or less than 9, or less than 8, or less than 7, or less than 6, or less than 5, or less than 4, or less than 3, as determined by the L*a*b* color system of the CIE (International Commission on Illumination).

In aspect 39, the invention relates to a polyester composition of any one of aspects 1-38, which can have any of the L* values of from 50 to 99, or from 50 to 90, or from 60 to 99, or from 60 to 90, or from 60 to 85, or from 60 to 80, or from 65 to 99, or from 65 to 90, or from 65 to 85, or from 65 to 80, or from 65 to 75, or from 70 to 90, or from 70 to 99, or from 70 to 90, or from 70 to 85, or from 70 to 80, or from 75 to 95, or from 75 to 90, or from 75 to 85, or from 80 to 90, as determined by the L*a*b* color system of the CIE (International Commission on Illumination).

In aspect 40, the invention relates to a polyester composition of any one of aspects 1-39, wherein said polyester can comprise residues of at least one branching agent.

In aspect 41, the invention relates to a polyester composition of any one of aspects 1-40, wherein said branching agent can be trimethylolpropane.

In aspect 42, the invention relates to a polyester composition of any one of aspects 1-41, wherein said at least one branching agent can be present in the polyesters according to the invention in the amounts of from 0 to 10 mole percent, or from 0.01 to 8 mole percent, or from 0.01 to 7 mole percent, or from 0.01 to 6 mole percent, or from 0.01 to 5 mole percent, or from 0.01 to 1 mole percent, or from 0.05 to 5 mole percent, or from 0.05 to 1 mole percent, or from 0.1 to 0.7 mole percent, based the total mole percentages of either the diol or diacid residues in the final polyester composition

In aspect 43, the invention relates to a polyester composition comprising:
(1) at least one polyester which comprises:
   (a) a dicarboxylic acid component comprising:
      (i) about 0.01 to about 50 mole % residues of terephthalic acid or esters thereof;
      (ii) about 50 to about 99.99 mole % residues of isophthalic acid or esters thereof;
      (iii) about 0 to about 30 mole % of aromatic or aliphatic dicarboxylic acid residues, or combinations thereof, having up to 20 carbon atoms;
   (b) a glycol component comprising:
      (i) about 20 to about 65 mole % of 2,2,4,4-tetramethyl-1,3-cyclobutanediol residues;
      (ii) about 0 to about 35 mole % of hexanediol residues; and
      (iii) about 0 to about 80 mole % of modifying glycol residues;
   wherein the total mole % of the dicarboxylic acid component is 100 mole %,
   wherein the total mole % of the diol component is 100 mole %; and
(2) residues of a catalyst system comprising: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

In aspect 44, the invention relates to a polyester composition of any one of aspects 23, 24, 25, 28, or 43, wherein at least one lithium source can be selected from lithium carbonate, lithium acetate, lithium benzoate, lithium succinate, lithium acetylacetonate, lithium methoxide, lithium oxalate, lithium nitrate, lithium ethoxide, lithium hydroxide, lithium hydride, lithium glycoxide, alkyl lithium, lithium aluminum hydride, lithium borohydride, and/or lithium oxide.

In aspect 45, the polyester composition of aspect 44 is provided, wherein at least one lithium source can be lithium acetylacetonate.

In aspect 46, the invention relates to a polyester composition of any one of aspects 23, 26, 27, 28, or 43, wherein at least one aluminum source can be selected from aluminum acetate, aluminum benzoate, aluminum sulfate, aluminum lactate, aluminum laurate, aluminum stearate, aluminum alcoholates, aluminum ethylate, aluminum isopropoxide, aluminum trin-butyrate, aluminum tri-tert-butyrate, mono-sec-butoxyaluminum diisopropylate, and aluminum chelates, which the alkoxy group of an aluminum alcoholate is partially or wholly substituted by a chelating agent such as an alkyl acetoacetate or acetylacetone, such as ethyl acetoacetate aluminum diisopropylate, aluminum tris(ethyl acetoacetate), alkyl acetoacetate, aluminum diisopropylate, aluminum monoacetylacetate bis(ethyl acetoacetate), aluminum tris(acetyl acetate), or aluminum acetylacetonate.

In aspect 47, the invention relates to a polyester composition of aspect 46, wherein at least one aluminum source can be selected from aluminum hydroxide, aluminum acetylacetonate, aluminum acetate, aluminum isopropoxide or aluminum sulfate.

In aspect 48, the invention relates to a polyester composition of aspect 47, wherein at least one aluminum source can be selected from aluminum acetylacetonate and aluminum isopropoxide.

In aspect 49, the invention relates to a polyester composition of any one of aspects 32-33 or 41, which can comprise at least one gallium compound with at least one organic substituent.

In aspect 50, the invention relates to a polyester composition of any one of aspects 32-33, 41, or 49, which can comprise at least one of the carboxylic acid salts of gallium.

In aspect 51, the invention relates to a polyester composition of any one of aspects 32-33, 41, 49-50, which can comprise at least one gallium source selected from gallium acetate, gallium benzoate, gallium sulfate, gallium lactate, gallium laurate, gallium stearate, gallium alcoholates, gallium ethylate, gallium isopropoxide, gallium tri-n-butyrate, gallium tri-tert-butyrate, mono-sec-butoxygallium diisopropylate, and gallium chelates, ethyl acetoacetate gallium diisopropylate, gallium tris(ethyl acetoacetate), gallium alkyl acetoacetate, gallium diisopropylate, gallium monoacetylacetate bis(ethyl acetoacetate), gallium tris(acetyl acetate), or gallium acetylacetonate.

In aspect 52, the invention relates to a polyester composition of any one of aspects 32-33, 41, or 49-51, which can comprise at least one gallium compound selected from gallium hydroxide, gallium acetylacetonate, gallium acetate, gallium isopropoxide or gallium sulfate.

In aspect 53, the invention relates to a polyester composition of any one of aspects 32-33, 41, or 49-52, which can comprise at least one gallium source selected from gallium acetylacetonate and gallium isopropoxide.

In aspect 54, the invention relates to a polyester composition of any one of aspects 32-33, 41 or 49-53, which can comprise at least one gallium source selected from gallium acetylacetonate.

In aspect 55, the invention relates to a polyester composition of any one of aspects 30-31, or 41, which can comprise at least one zirconium source selected from zirconium esters, phenolates, acylates and chelates.

In aspect 56, the invention relates to a polyester composition of any one of aspects 30-31, 41, or 55, which can comprise at least one zirconium source selected from zirconium acetyl acetoacetate and zirconium n-butoxide.

In aspect 57, the invention relates to a polyester composition of any one of aspects 30-31, 41, 55, or 56, which can comprise at least one zirconium source selected from zirconium acetylacetonate.

In aspect 58, the invention relates to a polyester composition of any one of aspects 1-57, which can have a final acid number of up to 10 mg KOH/g polymer. In all embodiments and examples herein, the acid number (AN) is expressed in mg KOH/g polymer.

In aspect 59, the invention relates to a polyester composition of any one of aspects 1-87 wherein the final hydroxyl number (OHN) can be up to 35 or up to 40 mg KOH/g of polymer. In all embodiments and examples herein, the hydroxyl number is expressed in mg KOH/g polymer.

In aspect 60, the invention relates to a polyester composition of any one of aspects 1-59, wherein said polyester composition can comprise a blend with at least one polymer chosen from at least one of the following: polyesters other than those in aspect 1 or other aspects referring to aspect 1, poly(etherimides), polyphenylene oxides, poly(phenylene oxide)/polystyrene blends, polystyrene resins, polyphenylene sulfides, polyphenylene sulfide/sulfones, poly(ester-carbonates), polycarbonates, polysulfones; polysulfone ethers, and poly(ether-ketones).

In aspect 61, the invention relates to a polyester composition of any one of aspects 1-60, which can comprise residues of at least one phosphorus compound.

In aspect 62, the invention relates to a polyester composition of any one of aspects 1-61, which can be a blend of the polyester with recycled poly(ethylene terephthalate)(rPET).

In aspect 63, the invention relates to a process of making any one of the polyesters or polyester compositions of aspects 1-62, wherein the extent of 2,2,4,4-tetramethyl-1,3-cyclobutanediol incorporation or conversion in the final polymer can be greater than 55 mole %, or greater than 50 mole %, or greater than 45 mole %, or greater than 40 mole %, or greater than 35 mole %, or greater than 30 mole %.

In aspect 64, the invention relates to a process for making the polyester or polyester composition of any of aspects 1-63.

In aspect 65, the invention relates to a process of any one of aspects 63-64, wherein the esterification catalyst(s) can be added after the start of the esterification.

In aspect 66, the invention relates to a process of any one of aspects 63-65, wherein the esterification catalyst(s) can be added after the start of the esterification but prior to pulling vacuum to make the polyesters or polyester compositions of the invention.

In aspect 67, the invention relates to a process of any one of aspects 63-66, wherein the esterification catalyst(s) can be added after the start of the esterification and from 0 to 40, or 0 to 35, or 0 to 30, or 0 to 25, or 0 to 20, or 0 to 15, or 1 to 40, or 1 to 35, or 1 to 30, or 1 to 25, or 1 to 20, or 1 to 15, or 5 to 40, or 5 to 35, or 5 to 30, or 5 to 25, or 5 to 20, or 5 to 15, or 10 to 40, or 10 to 35, or 10 to 30, or 10 to 25, or 10 to 20, or 10 to 15, or 15 to 40, or 15 to 35, or 15 to 30, or 15 to 25, or 15 to 20 minutes prior to pulling vacuum to make the polyesters or polyester compositions of the invention.

In aspect 68, the invention relates to a process of any one of aspects 63-67, wherein the esterification catalyst(s) can be added after the start of the esterification from 10 to 30, or 15 to 30, or 15 to 25 minutes, or 15 to 20 minutes prior to pulling vacuum to make the polyesters or polyester compositions of the invention.

In aspect 69, the invention relates to a process of any one of aspects 63-68, wherein the esterification catalyst(s) can be added after the start of the esterification when the polyol has an acid number of from 1 to 40, or 1 to 35, or 1 to 30, or 1 to 25, or 1 to 20, or 1 to 15, or 5 to 40, or 5 to 35, or 5 to 30, or 5 to 25, or 5 to 20, or 5 to 15, or 10 to 40, or 10 to 35, or 10 to 30, or 10 to 25, or 10 to 20, or 10 to 15, or 15 to 40, or 15 to 35, or 15 to 30, or 15 to 25 mg KOH/g polymer, to make the polyesters or polyester compositions of the invention.

In aspect 70, the invention relates to a process of any one of aspects 63-69, wherein the esterification catalyst(s) can be added after the start of the esterification when the polyol/polyester has an acid number of from 10 to 30, or from 10 to 25, or from 15 to 25 mg KOH/g polymer, to make the polyesters or polyester compositions of the invention.

In aspect 71, the invention relates to a process of any one of aspects 63-70, wherein the esterification catalyst(s) can be added after the start of the esterification when the polyol/polyester has an acid number of from 15 to 25 mg KOH/g polymer, to make the polyesters or polyester compositions of the invention.

In aspect 72, the invention relates to a product made by any of the processes herein or in aspects 63-71.

In aspect 73, the invention relates to an article of manufacture made with the polyester compositions of any of aspects 1-72.

In aspect 74, the invention relates to a shaped article made with the polyester compositions of any of aspects 1-73.

In aspect 75, the invention relates to a coating composition made with the polyester compositions of any of aspects 1-63.

In aspect 76, the polyester/polyol compositions of any of aspects 1-63 can be suitable for applications in coatings, such as automotive, industrial maintenance, and furniture, and in adhesives such as laminating adhesive. The polyester/polyol compositions are especially suitable for field-applied industrial maintenance coatings, automotive refinish coatings, wood coatings, can coatings, coatings for food packaging, and marine craft gelcoats).

In aspect 77, the invention relates to a polyester composition or a polyester or a polyol of any of aspects 1-63, whether or not containing the catalyst(s) described therein.

The processes of the invention have one or more advantages including but not limited to effective TMCD incorporation, good TMCD yield, good acid numbers, good hydroxyl numbers, good number average molecular weight, good inherent viscosities, good number average molecular weight, good clarity (good haze), and good color.

### BRIEF DESCRIPTION OF THE DRAWING(S)

FIG. 1. Impact of zirconium catalyst addition on Polyester A and acid number. The bars represent addition of catalyst at time zero and indicates addition of zirconium at the end of Stage 7 as indicated in the Examples. The dashed box is for the target number average molecular weight (Mn) and the acid number (AN) window.

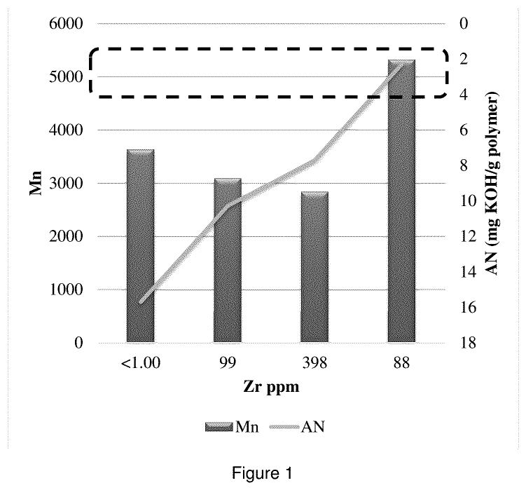

### DETAILED DESCRIPTION OF THE INVENTION

The present invention may be understood more readily by reference to the following detailed description of certain embodiments of the invention and the working examples. In accordance with the purpose(s) of this invention, certain embodiments of the invention are described in the Summary of the Invention and are further described herein below. Also, other embodiments of the invention are described herein.

This invention provides polyester compositions containing comprise 1,4-cyclohexanedimethanol, and/or 2,2,4,4-tetramethyl-1,3-cyclobutanediol, terephthalic acid, and isophthalic acid and novel catalyst systems and processes used to produce them. A distinct challenge has been found in effectiveness of transition metal catalysts for these polyesters/polyols in separating metal based esterification from the competing acid-catalyzed process at early reaction times. This invention is believed to solve this challenge.

This invention provides use of a catalyst system for making copolyesters, wherein the catalyst system comprises: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

This invention provides use of a catalyst system for making copolyesters can comprise 1,4-cyclohexanedimethanol, and/or 2,2,4,4-tetramethyl-1,3-cyclobutanediol, and optionally modifying glycols, terephthalic acid, and isophthalic acid which comprises: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

This invention also provides use of a catalyst system for making copolyesters or polyols can comprise 1,4-cyclohexanedimethanol, and/or 2,2,4,4-tetramethyl-1,3-cyclobutanediol, and optionally modifying glycols such as 2-methyl-1,3-propanediol (MPD), and trimethylolpropane (TMP), which comprises: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

This invention also provides use of a catalyst system for making copolyesters or polyols can comprise 1,4-cyclohexanedimethanol, and/or 2,2,4,4-tetramethyl-1,3-cyclobutanediol, and optionally modifying glycols such as hexanediol, which comprises: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

It is believed that certain polyesters and/or polyester composition(s) of the invention, and optionally, comprising certain catalysts and stabilizers, reaction products thereof, and mixtures thereof, can have a combination of one or more, two or more, or three or more, of including but not limited to effective TMCD incorporation, good TMCD yield, good acid numbers, good hydroxyl numbers, good inherent viscosities, good number average molecular weight, good clarity (lack of haze), and good color.

In one embodiment, these copolyesters can, over a range of compositions, be prepared with at least one lithium (Li) catalyst and at least one aluminum (Al) catalyst.

In one embodiment, these copolyesters can, over a range of compositions, be prepared with at least one gallium (Ga) catalyst.

In one embodiment, these copolyesters can, over a range of compositions, be prepared with at least one zirconium (Zr) catalyst.

It is believed that the color of these copolyesters can be improved with the addition during polymerization of certain levels of phosphorus containing compounds/stabilizers.

The present invention relates to these copolyesters catalyzed by certain catalyst types and/or amounts that provide improved properties (as discussed herein), and in certain embodiments, at least one lithium catalyst and at least one aluminum catalyst, or at least one gallium catalyst, or at least one zirconium catalyst, which can result in good TMCD incorporation, including but not limited to effective TMCD incorporation, good TMCD yield, good acid numbers, good hydroxyl numbers, good number average molecular weight, good inherent viscosities, good number average molecular weight, good clarity (lack of haze), and good color.

When lithium is added to the polyesters and/or polyester compositions and/or process of making the polyesters of the invention, it is added to the process of making the polyester in the form of a lithium compound. The amount of the lithium compound added to the polyesters of the invention and/or polyester compositions of the invention and/or processes of the invention can be measured in the form of lithium atoms present in the final polyester, for example, by weight measured in ppm.

When aluminum is added to the polyesters and/or polyester compositions and/or process of making the polyesters of the invention, it is added to the process of making the polyester in the form of an aluminum compound. The amount of the aluminum compound added to the polyesters of the invention and/or polyester compositions of the invention and/or processes of the invention can be measured in the form of aluminum atoms present in the final polyester, for example, by weight measured in ppm.

When gallium is added to the polyesters and/or polyester compositions and/or process of making the polyesters of the invention, it is added to the process of making the polyester in the form of a gallium compound. The amount of the gallium compound added to the polyesters of the invention and/or polyester compositions of the invention and/or processes of the invention can be measured in the form of gallium atoms present in the final polyester, for example, by weight measured in ppm.

When zirconium is added to the polyesters and/or polyester compositions and/or process of making the polyesters of the invention, it is added to the process of making the polyester in the form of a zirconium compound. The amount of the zirconium compound added to the polyesters of the invention and/or polyester compositions of the invention and/or processes of the invention can be measured in the form of zirconium atoms present in the final polyester, for example, by weight measured in ppm.

When phosphorus is added to the polyesters and/or polyester compositions and/or process of making the polyesters of the invention, it is added to the process of making the polyester in the form of a phosphorus compound. In one embodiment, this phosphorus compound can comprise at least one phosphate ester(s). The amount of phosphorus compound, [for example, phosphate ester(s)] added to the polyesters of the invention and/or polyester compositions of the invention and/or processes of the invention can be measured in the form of phosphorus atoms present in the final polyester, for example, by weight measured in ppm.

The term “polyester,” as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching agents. Typically, the difunctional carboxylic acid can be a dicarboxylic acid and the difunctional hydroxyl compound can be a dihydric alcohol such as, for example, glycols and diols. The term “glycol” as used herein includes, but is not limited to, diols, glycols, and/or multifunctional hydroxyl compounds, for example, branching agents. Alternatively, the difunctional carboxylic acid may be a hydroxy carboxylic acid such as, for example, p-hydroxybenzoic acid, and the difunctional hydroxyl compound may be an aromatic nucleus bearing 2 hydroxyl substituents such as, for example, hydroquinone. The term “residue,” as used herein, means any organic structure incorporated into a polymer through a polycondensation and/or an esterification reaction from the corresponding monomer. The term “repeating unit,” as used herein, means an organic structure having a dicarboxylic acid residue and a diol residue bonded through a carbonyloxy group. Thus, for example, the dicarboxylic acid residues may be derived from a dicarboxylic acid monomer or its associated acid halides, esters, salts, anhydrides, and/or mixtures thereof. Furthermore, as used herein, the term “diacid” includes multifunctional acids, for example, branching agents. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or mixtures thereof, useful in a reaction process with a diol to make polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make polyester.

The polyesters used in the present invention typically can be prepared from dicarboxylic acids and diols which react in substantially equal proportions and are incorporated into the polyester polymer as their corresponding residues. The polyesters of the present invention, therefore, can contain substantially equal molar proportions of acid residues (100 mole %) and diol (and/or multifunctional hydroxyl compound) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 10 mole % isophthalic acid, based on the total acid residues, means the polyester contains 10 mole % isophthalic acid residues out of a total of 100 mole % acid residues. Thus, there are 10 moles of isophthalic acid residues among every 100 moles of acid residues. In another example, a polyester containing 25 mole % TMCD, based on the total diol residues, means the polyester contains 25 mole % TMCD residues out of a total of 100 mole % diol residues. Thus, there are 25 moles of TMCD residues among every 100 moles.

In one embodiment, the invention relates to a polyester composition comprising:
(1) at least one polyester which comprises:
   (a) a dicarboxylic acid component comprising:
      (i) about 0.01 to about 50 mole % residues of terephthalic acid or esters thereof;
      (ii) about 50 to about 99.99 mole % residues of isophthalic acid or esters thereof;
      (iii) about 0 to about 30 mole % of aromatic or aliphatic dicarboxylic acid residues, or combinations thereof, having up to 20 carbon atoms;
   (b) a glycol component comprising:
      (i) about 25 to about 65 mole % of 1,4-cyclohexanedimethanol residues or 2,2,4,4-tetramethyl-1,3-cyclobutanediol residues; and
      (ii) about 35 to about 75 mole % of modifying glycol residues;
   wherein the total mole % of the dicarboxylic acid component is 100 mole %, and wherein the total mole % of the diol component is 100 mole %; and
(2) residues of a catalyst system comprising: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

In one embodiment, a polyester composition is provided wherein the modifying glycols can additionally comprise at least one of hexanediol, diethylene glycol, 1,2-propanediol, 1,3-propanediol, 2-methyl-1,3-propanediol, diethylene glycol, 1,4-butanediol, 1,5-pentanediol, p-xylene glycol, neopentyl glycol, isosorbide, polytetramethylene glycol, or combinations thereof.

In one embodiment, a polyester composition is provided wherein the modifying glycols can comprise 2-methyl-1,3-propanediol except where it is already specified as being present and is therefore, not a modifying glycol.

In one embodiment, a polyester composition is provided wherein the modifying glycols can comprise hexanediol except where is already specified as being present and it therefore, not a modifying glycol.

In one embodiment, a polyester composition is provided, wherein the modifying glycols can comprise ethylene glycol.

In one embodiment, a polyester composition is provided wherein the polyester can comprise 1,4-cyclohexanedimethanol residues in the amount of from about 25 to about 60 mole %, or from about 25 to about 55 mole %, or from about 25 to about 50 mole %, or from about 25 to about 45 mole %, or from about 25 to about 40 mole %, or from about 25 to about 35 mole %, or from about 30 to about 65 mole %, or from about 30 to about 60 mole %, or from about 30 to about 55 mole %, or from about 30 to about 50 mole %, or from about 30 to about 45 mole %, or from about 30 to about 40 mole %, or from about 30 to about 35 mole %, or from about 35 to about 65 mole %, or from about 35 to about 60 mole %, or from about 35 to about 55 mole %, or from about 35 to about 50 mole %, or from about 35 to about 45 mole %.

In one embodiment, a polyester composition is provided wherein the polyester can comprise residues of 2,2,4,4-tetramethyl-1,3-cyclobutanediol in the amount of from about 25 to about 60 mole %, or from about 25 to about 55 mole %, or from about 25 to about 50 mole %, or from about 25 to about 45 mole %, or from about 25 to about 40 mole %, or from about 25 to about 35 mole %, or from about 30 to about 65 mole %, or from about 30 to about 60 mole %, or from about 30 to about 55 mole %, or from about 30 to about 50 mole %, or from about 30 to about 45 mole %, or from about 30 to about 40 mole %, or from about 30 to about 35 mole %, or from about 35 to about 65 mole %, or from about 35 to about 60 mole %, or from about 35 to about 55 mole %, or from about 35 to about 50 mole %, or from about 35 to about 45 mole %.

In one embodiment, a polyester composition is provided wherein the polyester can comprise less than 55 mole %, or less than 50 mole %, or less than 40 mole %, or less than 35 mole %, or less than 30 mole %, or less than 25 mole %, or less than 20 mole %, or less than 15 mole %, or less than 10 mole %, or 0 mole % of ethylene glycol residues, based on the total mole percentages of glycol residues in the final polyester equaling 100 mole %.

In one embodiment, a polyester composition is provided wherein the polyester can comprise less than 55 mole %, or less than 50 mole %, or less than 40 mole %, or less than 35 mole %, or less than 30 mole %, or less than 25 mole %, or less than 20 mole %, or less than 15 mole %, or less than 10 mole %, or 0 mole % of neopentyl glycol residues, based on the total mole percentages of glycol residues in the final polyester equaling 100 mole %.

In one embodiment, a polyester composition is provided wherein the polyester can comprise or less than 50 mole %, or less than 40 mole %, or less than 35 mole %, or less than 30 mole %, or less than 25 mole %, or less than 20 mole %, or less than 15 mole %, or less than 10 mole %, or 0 mole % of cyclohexanedicarboxylic acid residues, based on the total mole percentages of acid residues in the final polyester equaling 100 mole %.

In one embodiment, a polyester composition is provided, wherein the polyester can comprise residues of 2,2,4,4-tetramethyl-1,3-cyclobutanediol to 1,4-cyclohexanedimethanol in molar ratios of 1:3 to 3:1, or from 1:2 to 2:1, or from 1:1.5 to 1.5:1, or from 1:1.25 to 1.25:1.

In one embodiment, a polyester composition is provided comprising:
(1) at least one polyester which can comprise:
   (a) a dicarboxylic acid component comprising:
      (i) about 5 to about 40 mole %, or about 10 to 35 mole % residues of terephthalic acid or esters thereof;
      (ii) about 60 to about 95 mole %, or about 65 to about 90 mole % residues of isophthalic acid or esters thereof;
      (iii) about 0 to about 25 mole % of aromatic or aliphatic dicarboxylic acid residues, or combinations thereof, having up to 20 carbon atoms;
   (b) a glycol component comprising:
      (i) about 25 to about 65 mole % each of 1,4-cyclohexanedimethanol residues and/or 2,2,4,4-tetramethyl-1,3-cyclobutanediol residues; wherein the total mole percentage of both glycols cannot exceed 95 mole %;
      (ii) about 5 to about 25 mole % of hexanediol residues; and
      (iii) about 0 to about 70 mole % of modifying glycol residues;
   wherein the total mole % of the dicarboxylic acid component is 100 mole %,
   wherein the total mole % of the diol component is 100 mole %; and
(2) residues of a catalyst system comprising: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

In one embodiment, a polyester composition is provided comprising:
(1) at least one polyester which can comprise:
   (a) a dicarboxylic acid component comprising:
      (i) about 5 to about 40 mole %, or about 10 to about 35 mole % residues of terephthalic acid or esters thereof;
      (ii) about 60 to about 95 mole %, or about 65 to about 90 mole %, or about 70 to about 90 mole % residues of isophthalic acid or esters thereof;
      (iii) about 0 to about 25 mole % of aromatic or aliphatic dicarboxylic acid residues, or combinations thereof, having up to 20 carbon atoms;
   (b) a glycol component comprising:
      (i) about 35 to about 50 mole % each of 1,4-cyclohexanedimethanol residues and/or 2,2,4,4-tetramethyl-1,3-cyclobutanediol residues, wherein the total mole percentages of the combinations of both glycols cannot exceed 94.5 mole %;
      (ii) about 5 to about 20 mole % of 2-methyl-1,3-propanediol residues; and
      (iii) optionally, about 0.5 to about 5 mole % of trimethylolpropane residues;
      (iv) about 0 to about 69.5 mole % of modifying glycol residues;
   wherein the total mole % of the dicarboxylic acid component is 100 mole %, wherein the total mole % of the diol component is 100 mole %; and
(2) residues of a catalyst system comprising: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

In one embodiment, a polyester composition is provided, wherein the polyester can comprise residues of 2,2,4,4-tetramethyl-1,3-cyclobutanediol to hexanediol in molar ratios of 1:3 to 3:1, or from 1:2 to 2:1, or from 2.5:0.5 to 0.5:2.5, or from 2.5:0.5, or from 2:1.

In one embodiment, a polyester composition is provided, wherein the polyester can comprise residues of 1,4-cyclohexanedimethanol to residues of hexanediol in molar ratios of 1:3 to 3:1, or from 1:2 to 2:1, or from 2.5:0.5 to 0.5:2.5, or from 2.5:0.5, or from 2:1.

In one embodiment, a polyester composition is provided, wherein the polyester can comprise residues of a diacid component comprising aromatic or aliphatic dicarboxylic acid ester residues, or combinations thereof.

In one embodiment, a polyester composition is provided, wherein the polyester can comprise residues of a dicarboxylic acid component comprising:
(i) about 0.01 to about 50 mole % residues of terephthalic acid or esters thereof; and
(ii) about 50 to about 99.99 mole % residues of isophthalic acid or esters thereof.

In one embodiment, a polyester composition is provided, wherein the polyester comprises residues of a dicarboxylic acid component comprising:
(i) about 5 to about 40 mole %, or about 10 to about 35 mole % residues of terephthalic acid or esters thereof; and
(ii) about 60 to about 95 mole %, or about 65 to about 90 mole %, or about 70 to about 90 mole % residues of isophthalic acid or esters thereof.

In one embodiment, a polyester composition is provided, wherein the polyester comprises residues of terephthalic acid to isophthalic acid in molar ratios of from 1:10 to 10:1, or from 1:9 to 9:1, or from 1:8 to 8:1, or from 1:7 to 7:1, or from 1:6 to 6:1, or from 1:5 to 5:1, or from 1:4 to 4:1, or from 1:5 to 5:1, or from 1:3 to 3:1, or from 1:2 to 2:1, or from 1:10 to 1:2, or from 1:9 to 1:2, or 1:9, or 1:8, or 1:7, or 1:6, or 1:5, 1:4, or 1:3, or 1:2.

In one embodiment, a polyester composition is provided, wherein the 2,2,4,4-tetramethyl-1,3-cyclobutanediol residues are a combination which can comprise greater than 50 mole % of cis-2,2,4,4-tetramethyl-1,3-cyclobutanediol and less than 50 mole % of trans-2,2,4,4-tetramethyl-1,3-cyclobutanediol, or greater than 70 mole % of cis-2,2,4,4-tetramethyl-1,3-cyclobutanediol and less than 30 mole % of trans-2,2,4,4-tetramethyl-1,3-cyclobutanediol, or greater than 75 mole % of cis-2,2,4,4-tetramethyl-1,3-cyclobutanediol and less than 25 mole % of trans-2,2,4,4-tetramethyl-1,3-cyclobutanediol, or greater than 80 mole % of cis-2,2,4,4-tetramethyl-1,3-cyclobutanediol and less than 20 mole % of trans-2,2,4,4-tetramethyl-1,3-cyclobutanediol, or greater than 85 mole % of cis-2,2,4,4-tetramethyl-1,3-cyclobutanediol and less than 15 mole % of trans-2,2,4,4-tetramethyl-1,3-cyclobutanediol, or greater than 90 mole % of cis-2,2,4,4-tetramethyl-1,3-cyclobutanediol and less than 10 mole % of trans-2,2,4,4-tetramethyl-1,3-cyclobutanediol, or greater than 95 mole % of cis-2,2,4,4-tetramethyl-1,3-cyclobutanediol and less than 5 mole % of trans-2,2,4,4-tetramethyl-1,3-cyclobutanediol.

In one embodiment, the polyesters and/or polyester compositions of the invention can comprise CHDM. The molar ratio of cis/trans CHDM can vary within the range of 50/50 to 0/100, for example, between 40/60 to 20/80.

In one embodiment, terephthalic acid and/or isophthalic acid may be used as the starting material. In another embodiment, dimethyl terephthalate may be used as the starting material. In yet another embodiment, mixtures of terephthalic acid and dimethyl terephthalate may be used as the starting material and/or as an intermediate material.

In certain embodiments, terephthalic acid and/or isophthalic acid, and/or esters thereof, such as, for example, dimethyl terephthalate or a mixture of terephthalic acid residues and an ester thereof can make up a portion or all of the dicarboxylic acid component used to form the polyesters and/or polyester compositions of the invention. In certain embodiments, terephthalic acid residues and/or isophthalic acid can make up a portion or all of the dicarboxylic acid component used to form the polyesters and/or polyester compositions of the invention. For purposes of this disclosure, the terms “terephthalic acid” and “dimethyl terephthalate” are used interchangeably herein

In one embodiment, (a) the diacid component can comprise terephthalic acid or esters thereof, such as dimethyl terephthalate, of the polyesters of the invention can comprise 0.01 to 50 mole %, or 0.01 to 45 mole %, or 0.01 to 40 mole %, or 0.01 to 35 mole % of terephthalic acid, or 0.01 to 40 mole %, or 0.01 to 35 mole %, or less than 35 mole %, or less than 30 mole %, or less than 20 mole %, or less than 10 mole %, or less than 5 mole % of terephthalic acid; (b) the isophthalic acid component can comprise from 50 to 99.99 mole %, or 55 to 99.99 mole %; 60 to 99.99 mole %, 65 to 99.99 mole, or 65 to 90 mole %, or from 65 to 85 mole %, or from 65 to 80 mole %, 70 to 90 mole %, or from 70 to 85 mole %, or from 70 to 80 mole %, or from 75 to 90 mole %, or from 80 to 90 mole %, % of isophthalic acid, and/or (c) from 0 to 49.99, or from 0 to 40 mole %, or from 0 to 30 mole %, or from 0 to 20 mole %, or from 0 to 15 mole %, or from 0 to 10 mole %, or from 0 to 5 mole %, or from 0.01 to 49.99, or from 0.01 to 40 mole %, or from 0.01 to 30 mole %, or from 0.01 to 20 mole %, or from 0.01 to 15 mole %, or from 0.01 to 10 mole %, or from 0.01 to 5 mole %, or 0.1 to 10 mole %, or 1 or 10 mole %, or 0.01 to 5 mole %, or 0.1 to 5 mole %, or 1 or 5, or 0.01 to 1 mole %, or 0.1 to 1 mole %, or 5 to 10 mole %, or 0 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, 0.01 to 10 mole %, from 0.01 to 5 mole % and from 0.01 to 1 mole %. In one embodiment, modifying aromatic dicarboxylic acids that may be used in the present invention include but are not limited to those having up to 20 carbon atoms, and which can be linear, para-oriented, or symmetrical. Examples of modifying aromatic dicarboxylic acids which may be used in this invention include, but are not limited to, 4,4′-biphenyldicarboxylic acid, 1,4-, 1,5-, 2,6-, 2,7-naphthalenedicarboxylic acid, and trans-4,4′-stilbenedicarboxylic acid, and esters thereof.

The carboxylic acid component of the polyesters and/or polyester compositions of the invention can be further modified with less than 50 mole %, less than 49.99 mole, or less than 40 mole %, or 30 mole %, or less than 20 mole %, or less than 10 mole %, or less than 5 mole %, or from 0 to 30 mole %, or from 0 to 20 mole %, or from 0 to 10 mole %, or from 0 to 5 mole %, or from 0 to 1 mole %, or 0.01 to 10 mole %, or 0.1 to 10 mole %, or 1 or 10 mole %, or 0.01 to 5 mole %, or 0.1 to 5 mole %, or 1 or 5, or 0.01 to 1 mole %, or 0.1 to 1 mole %, or 5 to 10 mole %, or 0 mole % of one or more aliphatic dicarboxylic acids containing 2-16 carbon atoms, such as, for example, cyclohexanedicarboxylic, malonic, succinic, glutaric, adipic, pimelic, suberic, azelaic and dodecanedioic dicarboxylic acids. Certain embodiments can also comprise 0.01 to 10 mole %, such as 0.1 to 10 mole %, 1 or 10 mole %, 5 to 10 mole % of one or more modifying aliphatic dicarboxylic acids. Yet another embodiment contains 0 mole % modifying aliphatic dicarboxylic acids. The total mole % of the dicarboxylic acid component is 100 mole %. In one embodiment, adipic acid and/or glutaric acid are provided in the modifying aliphatic dicarboxylic acid component of the invention.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

In one embodiment, the polyesters and/or polyester compositions of the invention can comprise less than 50 mole %, or less than 40 mole %, or less than 35 mole %, or less than 30 mole %, or less than 25 mole %, or less than 20 mole %, or less than 15 mole %, or less than 10 mole %, or less than 5 mole %, or from 0 to 30 mole %, or from 0 to 20 mole %, or from 0 to 10 mole %, or from 0 to 5 mole %, or from 0 to 1 mole %, or 0.01 to 10 mole %, or 0.1 to 10 mole %, or 1 or 10 mole %, or 0.01 to 5 mole %, or 0.1 to 5 mole %, or 1 or 5, or 0.01 to 1 mole %, or 0.1 to 1 mole %, or 5 to 10 mole %, or 0 mole % of cyclohexanedicarboxylic acid (CHDA) residues, based on the total mole percentages of acid residues in the final polyester equaling 100 mole %.

In one embodiment, the polyesters and/or polyester compositions of the invention can comprise trans-CHDA in an amount less than 50 mole %, or less than 40 mole %, or less than 35 mole %, or less than 30 mole %, or less than 25 mole %, or less than 20 mole %, or less than 15 mole %, or less than 10 mole %, or less than 5 mole %, or from 0 to 30 mole %, or from 0 to 20 mole %, or from 0 to 10 mole %, or from 0 to 5 mole %, or from 0 to 1 mole %, or 0.01 to 10 mole %, or 0.1 to 10 mole %, or 1 or 10 mole %, or 0.01 to 5 mole %, or 0.1 to 5 mole %, or 1 or 5, or 0.01 to 1 mole %, or 0.1 to 1 mole %, or 5 to 10 mole %, or 0 mole %, based on the total mole percentages of acid residues in the final polyester equaling 100 mole %.

In one embodiment, a polyester composition is provided, wherein the inherent viscosity can be from 0.10 to 0.70 dL/g, or from 0.10 to 0.65 dL/g, or from 0.10 to 0.60 dL/g, or from 0.10 to 0.55 dL/g, or from 0.10 to 0.50 dL/g, or from 0.10 to 0.45 dL/g, or from 0.15 to 0.40 dL/g, or from 0.10 to 0.35 dL/g, or from 0.20 to 0.30 dL/g, or from 0.15 to 0.70 dL/g, or from 0.15 to 0.65 dL/g, or from 0.15 to 0.60 dL/g, or from 0.15 to 0.55 dL/g, or from 0.15 to 0.50 dL/g, from 0.15 to 0.45 dL/g, or from 0.20 to 0.40 dL/g, or from 0.15 to 0.35 dL/g, from 0.15 to 0.30 dL/g, 0.20 to 0.50 dL/g, or from 0.20 to 0.45 dL/g, or from 0.15 to 0.40 dL/g, or from 0.20 to 0.35 dL/g, or from 0.20 to 0.30 dL/g, or from 0.20 to 0.29 dL/g, or from 0.20 to 0.28 dL/g, or from 0.22 to 0.26 dL/g, or from or from 0.25 to 0.50 dL/g, from 0.25 to 0.45 dL/g, or from 0.25 to 0.40 dL/g, or from 0.20 to 0.35 dL/g, or from 0.25 to 0.30 dL/g, or at least 0.10 dL/g, or at least 0.15 dL/g, or at least 0.2 dL/g, as determined in 60/40 (wt/wt) phenol/tetrachloroethane at a concentration of 0.5 g/100 ml at 25° C.

In one embodiment, a polyester composition is provided, wherein the number average molecular weight can be from 2000 to 8000, or from 2000 to 7500, or from 2000 to 7000, or from 2000 to 6500, or from 2000 to 6000, or from 2000 to 5500, or from 2000 to 5000, or from 2500 to 8000, or from 2500 to 7500, or from 2500 to 7000, or from 2500 to 6500, or from 2500 to 6000, or from 2500 to 5500, or from 2500 to 5000, from 3000 to 8000, or from 3000 to 7500, or from 3000 to 7000, or from 3000 to 6500, or from 3000 to 6000, or from 3000 to 5500, or from 3000 to 5000, from 4000 to 8000, or from 4000 to 7500, or from 4000 to 7000, or from 4000 to 6500, or from 4000 to 6000, or from 4000 to 5500, or from 4000 to 5000, or from 4500 to 5000.

In one embodiment, the invention relates to a polyester composition comprising:
(1) at least one polyester which can comprise:
   (a) a dicarboxylic acid component comprising:
      (i) about 5 to about 40 mole %, or about 10 to 35 mole % residues of terephthalic acid or esters thereof;
      (ii) about 60 to about 95 mole %, or about 65 to about 90 mole % residues of isophthalic acid or esters thereof;
      (iii) about 0 to about 25 mole % of aromatic or aliphatic dicarboxylic acid residues, or combinations thereof, having up to 20 carbon atoms;
   (b) a glycol component comprising:
      (i) about 25 to about 65 mole % each of 1,4-cyclohexanedimethanol residues and/or 2,2,4,4-tetramethyl-1,3-cyclobutanediol residues; wherein the total mole percentage of both glycols cannot exceed 95 mole %;
      (ii) about 5 to about 25 mole % of hexanediol residues; and
      (iii) about 0 to about 70 mole % of modifying glycol residues;
   wherein the total mole % of the dicarboxylic acid component is 100 mole %, wherein the total mole % of the diol component is 100 mole %; and
(2) residues of a catalyst system comprising: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

In one embodiment, the invention relates to a polyester composition comprising:
(1) at least one polyester which can comprise:
   (a) a dicarboxylic acid component comprising:
      (i) about 5 to about 40 mole %, or about 10 to about 35 mole % residues of terephthalic acid or esters thereof;
      (ii) about 60 to about 95 mole %, or about 65 to about 90 mole %, or about 70 to about 90 mole % residues of isophthalic acid or esters thereof;
      (iii) about 0 to about 25 mole % of aromatic or aliphatic dicarboxylic acid residues, or combinations thereof, having up to 20 carbon atoms;
   (b) a glycol component comprising:
      (i) about 35 to about 50 mole % each of 1,4-cyclohexanedimethanol residues and/or 2,2,4,4-tetramethyl-1,3-cyclobutanediol residues, wherein the total mole percentages of the combinations of both glycols cannot exceed 94.5 mole %;
      (ii) about 5 to about 20 mole % of 2-methyl-1,3-propanediol residues; and
      (iii) optionally, about 0.5 to about 5 mole % of trimethylolpropane residues;
      (iv) about 0 to about 69.5 mole % of modifying glycol residues;
   wherein the total mole % of the dicarboxylic acid component is 100 mole %, wherein the total mole % of the diol component is 100 mole %; and
(2) residues of a catalyst system comprising: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

In one embodiment, the invention relates to a polyester composition, wherein the polyester can comprise residues of at least one branching agent.

In one embodiment, the invention relates to a polyester composition, wherein the branching agent can be trimethylolpropane.

In one embodiment, the invention relates to a polyester composition, wherein the at least one branching agent can be present in the polyesters according to the invention in the amounts of from 0 to 10 mole percent, or 0.01 to 10 mole percent, or 0.01 to 9 mole percent, or from 0.01 to 8 mole percent, or from 0.01 to 7 mole percent, or from 0.01 to 6 mole percent, or from 0.01 to 5 mole percent, or from 0.01 to 1 mole percent, or from 0.05 to 5 mole percent, or from 0.05 to 1 mole percent, or from 0.1 to 0.7 mole percent, based the total mole percentages of either the diol or diacid residues in the final polyester composition.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction combination or blended with the polyester in the form of a concentrate as described, for example, in U.S. Pat. Nos. 5,654,347 and 5,696,176, whose disclosure regarding branching monomers is incorporated herein by reference.

The polyesters of the invention can comprise at least one chain extender. Suitable chain extenders include, but are not limited to, multifunctional (including, but not limited to, bifunctional) isocyanates, multifunctional epoxides, including for example epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but is generally about 0.1 percent by weight to about 10 percent by weight, such as about 0.1 to about 5 percent by weight, based on the total weight of the polyester.

In one embodiment, the polyesters and/or polyester compositions of the invention can comprise at least one phosphorus compound.

In one embodiment, the phosphorus compound(s) can be an organic compound such as, for example, a phosphorus acid ester containing halogenated or non-halogenated organic substituents. In certain embodiments, the phosphorus compound(s) can comprise a wide range of phosphorus compounds, for example, phosphines, phosphites, phosphinites, phosphonites, phosphinates, phosphonates, phosphine oxides, and phosphates.

Examples of phosphorus compounds that may be useful in the invention can include tributyl phosphate, triethyl phosphate, tri-butoxyethyl phosphate, t-butylphenyl diphenyl phosphate, 2-ethylhexyl diphenyl phosphate, ethyl dimethyl phosphate, isodecyl diphenyl phosphate, trilauryl phosphate, triphenyl phosphate, tricresyl phosphate, trixylenyl phosphate, t-butylphenyl diphenylphosphate, resorcinol bis(diphenyl phosphate), tribenzyl phosphate, phenyl ethyl phosphate, trimethyl thionophosphate, phenyl ethyl thionophosphate, dimethyl methylphosphonate, diethyl methylphosphonate, diethyl pentylphosphonate, dilauryl methylphosphonate, diphenyl methylphosphonate, dibenzyl methylphosphonate, diphenyl dimethyl cresylphosphonate, dimethyl cresylphosphonate, methylthionophosphonate, phenyl diphenylphosphinate, benzyl diphenylphosphinate, methyl diphenylphosphinate, trimethyl phosphine oxide, triphenyl phosphine oxide, tribenzyl phosphine oxide, 4-methyl diphenyl phosphine oxide, triethyl phosphite, tributyl phosphite, trilauryl phosphite, triphenyl phosphite, tribenzyl phosphite, phenyl diethyl phosphite, phenyl dimethyl phosphite, benzyl dimethyl phosphite, dimethyl methylphosphonite, diethyl pentylphosphonite, diphenyl methylphosphonite, dibenzyl methylphosphonite, dimethyl cresylphosphonite, methyl dimethylphosphinite, methyl diethylphosphinite, phenyl diphenylphosphinite, methyl diphenylphosphinite, benzyl diphenylphosphinite, triphenyl phosphine, tribenzyl phosphine, and methyl diphenyl phosphine. In one embodiment, triphenyl phosphine oxide is excluded as a thermal stabilizer in the process(es) of making the polyesters of the invention and/or in the polyester composition(s) of the invention.

In one embodiment, phosphorus compounds useful in the invention can be any of the previously described phosphorus-based acids wherein one or more of the hydrogen atoms of the acid compound (bonded to either oxygen or phosphorus atoms) are replaced with alkyl, branched alkyl, substituted alkyl, alkyl ethers, substituted alkyl ethers, alkyl-aryl, alkyl-substituted aryl, aryl, substituted aryl, and combinations thereof. In another embodiment, phosphorus compounds useful in the invention, include but are not limited to, the above described compounds wherein at least one of the hydrogen atoms bonded to an oxygen atom of the compound is replaced with a metallic ion or an ammonium ion.

The esters can contain alkyl, branched alkyl, substituted alkyl, alkyl ethers, aryl, and/or substituted aryl groups. The esters can also have at least one alkyl group and at least one aryl group. The number of ester groups present in the particular phosphorus compound can vary from zero up to the maximum allowable based on the number of hydroxyl groups present on the phosphorus compound used. For example, an alkyl phosphate ester can include one or more of the mono-, di-, and tri alkyl phosphate esters; an aryl phosphate ester includes one or more of the mono-, di-, and tri aryl phosphate esters; and an alkyl phosphate ester and/or an aryl phosphate ester also include, but are not limited to, mixed alkyl aryl phosphate esters having at least one alkyl and one aryl group.

In one embodiment, the phosphorus compounds useful in the invention include but are not limited to alkyl, aryl or mixed alkyl aryl esters or partial esters of phosphoric acid, phosphorus acid, phosphinic acid, phosphonic acid, or phosphonous acid. The alkyl or aryl groups can contain one or more substituents.

In one embodiment, the phosphorus compounds useful in the invention comprise at least one phosphorus compound chosen from at least one of substituted or unsubstituted alkyl phosphate esters, substituted or unsubstituted aryl phosphate esters, substituted or unsubstituted mixed alkyl aryl phosphate esters, diphosphites, salts of phosphoric acid, phosphine oxides, and mixed aryl alkyl phosphites, reaction products thereof, and combinations thereof. The phosphate esters include esters in which the phosphoric acid is fully esterified or only partially esterified.

In one embodiment, for example, the phosphorus compounds useful in the invention can include at least one phosphate ester.

In one embodiment, the phosphorus compounds useful in the invention comprise at least one phosphorus compound chosen from at least one of substituted or unsubstituted alkyl phosphate esters, substituted or unsubstituted aryl phosphate esters, substituted or unsubstituted mixed alkyl aryl phosphate esters, reaction products thereof, and combinations thereof. The phosphate esters include esters in which the phosphoric acid is fully esterified or only partially esterified.

In one embodiment, for example, the phosphorus compounds useful in the invention can include at least one phosphate ester.

In another embodiment, the phosphate esters useful in the invention can include but are not limited to alkyl phosphate esters, aryl phosphate esters, mixed alkyl aryl phosphate esters, and/or combinations thereof.

In certain embodiments, the phosphate esters useful in the invention are those where the groups on the phosphate ester include are alkyl, alkoxy-alkyl, phenyl, or substituted phenyl groups. These phosphate esters are generally referred to herein as alkyl and/or aryl phosphate esters. Certain preferred embodiments include trialkyl phosphates, triaryl phosphates, alkyl diaryl phosphates, dialkyl aryl phosphates, and combinations of such phosphates, wherein the alkyl groups are preferably those containing from 2 to 12 carbon atoms, and the aryl groups are preferably phenyl.

Representative alkyl and branched alkyl groups are preferably those containing from 1-12 carbon atoms, including, but not limited to, ethyl, propyl, isopropyl, butyl, hexyl, cyclohexyl, 2-ethylhexyl, octyl, decyl and dodecyl. Substituted alkyl groups include, but are not limited to, those containing at least one of carboxylic acid groups and esters thereof, hydroxyl groups, amino groups, keto groups, and the like.

Representative of alkyl-aryl and substituted alkyl-aryl groups are those wherein the alkyl portion contains from 1-12 carbon atoms, and the aryl group is phenyl or substituted phenyl wherein groups such as alkyl, branched alkyl, aryl, hydroxyl, and the like are substituted for hydrogen at any carbon position on the phenyl ring. Preferred aryl groups include phenyl or substituted phenyl wherein groups such as alkyl, branched alkyl, aryl, hydroxyl, and the like are substituted for hydrogen at any position on the phenyl ring.

In one embodiment, the phosphate esters useful in the invention include but are not limited to dibutylphenyl phosphate, triphenyl phosphate, tricresyl phosphate, tributyl phosphate, tri-2-ethylhexyl phosphate, trioctyl phosphate, and/or combinations thereof, including particularly combinations of tributyl phosphate and tricresyl phosphate, and combinations of isocetyl diphenyl phosphate and 2-ethylhexyl diphenyl phosphate.

In one embodiment, at least one phosphorus compound useful in the invention comprises at least one aryl phosphate ester.

In one embodiment, at least one phosphorus compound useful in the invention comprises at least one unsubstituted aryl phosphate ester.

In one embodiment, at least one phosphorus compound useful in the invention comprises at least one aryl phosphate ester which is not substituted with benzyl groups.

In one embodiment, any of the phosphorus compounds useful in the invention may comprise at least one alkyl phosphate ester.

In one embodiment, the phosphate esters useful in the invention as thermal stabilizers and/or color stabilizers include but are not limited to, at least one of the following: trialkyl phosphates, triaryl phosphates, alkyl diaryl phosphates, and mixed alkyl aryl phosphates.

In one embodiment, the phosphate esters useful in the invention as thermal stabilizers and/or color stabilizers include but are not limited to, at least one of the following: triaryl phosphates, alkyl diaryl phosphates, and mixed alkyl aryl phosphates.

In one embodiment, the phosphate esters useful as thermal stabilizers and/or color stabilizers in the invention can include but are not limited to, at least one of the following: triaryl phosphates and mixed alkyl aryl phosphates.

In one embodiment, at least one phosphorus compound useful in the invention can comprise, but is not limited to, triaryl phosphates, such as, for example, triphenyl phosphate. In one embodiment, at least one thermal stabilizer comprises, but is not limited to Merpol A. In one embodiment, at least one thermal stabilizer useful in the invention comprises, but is not limited to, at least one of triphenyl phosphate and Merpol A. Merpol A is a phosphate ester commercially available from Stepan Chemical Co and/or E.I. duPont de Nemours & Co. The CAS Registry number for Merpol A is believed to be CAS Registry #37208-27-8.

In one embodiment, any of the phosphorus compounds useful in the invention may comprise at least one triaryl phosphate ester which is not substituted with benzyl groups.

In one embodiment, the polyester compositions and/or processes of the invention may comprise 2-ethylhexyl diphenyl phosphate.

In one embodiment, any of the processes described herein for making any of the polyester compositions and/or polyesters can comprise at least one mixed alkyl aryl phosphite, such as, for example, bis(2,4-dicumylphenyl) pentaerythritol diphosphite also known as Doverphos S-9228 (Dover Chemicals, CAS #15486243-8).

In one embodiment, any of the processes described herein for making any of the polyester compositions and/or polyesters can comprise at least one phosphine oxide.

In one embodiment, any of the processes described herein for making any of the polyester compositions and/or polyesters can comprise at least one salt of phosphoric acid such as, for example, KH2PO4 and Zn3(PO4)2.

The term “thermal stabilizer” is intended to include the reaction product(s) thereof. The term “reaction product” as used in connection with the thermal stabilizers of the invention refers to any product of a polycondensation or esterification reaction between the thermal stabilizer and any of the monomers used in making the polyester as well as the product of a polycondensation or esterification reaction between the catalyst and any other type of additive.

In one embodiment of the invention, the phosphorus compounds useful in the invention may act as thermal stabilizers. In one embodiment of the invention, the phosphorus compounds useful in the invention may not act as a thermal stabilizer but may act as a color stabilizer. In one embodiment of the invention, the phosphorus compounds useful in the invention may act as both a thermal stabilizer and a color stabilizer.

In one embodiment, amounts of the phosphate ester of the invention added during polymerization are chosen from the following: 10 to 200 ppm based on the total weight of the polyester composition and as measured in the form of phosphorus atoms in the final polyester. In embodiments of the invention, phosphorous can be present in an amount of 10 to 100, or 10 to 80, or 10 to 60, or 10 to 55, or 15 to 55, or 18 to 52, or 20 to 50 ppm, based on the total weight of the polyester composition and as measured in the form of phosphorus atoms in the final polyester.

In one embodiment, the polyesters and/or polyester compositions of the invention can comprise at least one phosphorus compound.

In one embodiment, the phosphorus compound(s) can be an organic compound such as, for example, a phosphorus acid ester containing halogenated or non-halogenated organic substituents. In certain embodiments, the phosphorus compound(s) can comprise a wide range of phosphorus compounds, for example, phosphines, phosphites, phosphinites, phosphonites, phosphinates, phosphonates, phosphine oxides, and phosphates.

Examples of phosphorus compounds that may be useful in the invention can include tributyl phosphate, triethyl phosphate, tri-butoxyethyl phosphate, t-butylphenyl diphenyl phosphate, 2-ethylhexyl diphenyl phosphate, ethyl dimethyl phosphate, isodecyl diphenyl phosphate, trilauryl phosphate, triphenyl phosphate, tricresyl phosphate, trixylenyl phosphate, t-butylphenyl diphenylphosphate, resorcinol bis(diphenyl phosphate), tribenzyl phosphate, phenyl ethyl phosphate, trimethyl thionophosphate, phenyl ethyl thionophosphate, dimethyl methylphosphonate, diethyl methylphosphonate, diethyl pentylphosphonate, dilauryl methylphosphonate, diphenyl methylphosphonate, dibenzyl methylphosphonate, diphenyl cresylphosphonate, dimethyl cresylphosphonate, dimethyl methylthionophosphonate, phenyl diphenylphosphinate, benzyl diphenylphosphinate, methyl diphenylphosphinate, trimethyl phosphine oxide, triphenyl phosphine oxide, tribenzyl phosphine oxide, 4-methyl diphenyl phosphine oxide, triethyl phosphite, tributyl phosphite, trilauryl phosphite, triphenyl phosphite, tribenzyl phosphite, phenyl diethyl phosphite, phenyl dimethyl phosphite, benzyl dimethyl phosphite, dimethyl methylphosphonite, diethyl pentylphosphonite, diphenyl methylphosphonite, dibenzyl methylphosphonite, dimethyl cresylphosphonite, methyl dimethylphosphinite, methyl diethylphosphinite, phenyl diphenylphosphinite, methyl diphenylphosphinite, benzyl diphenylphosphinite, triphenyl phosphine, tribenzyl phosphine, and methyl diphenyl phosphine. In one embodiment, triphenyl phosphine oxide is excluded as a thermal stabilizer in the process(es) of making the polyesters of the invention and/or in the polyester composition(s) of the invention.

In one embodiment, phosphorus compounds useful in the invention can be any of the previously described phosphorus-based acids wherein one or more of the hydrogen atoms of the acid compound (bonded to either oxygen or phosphorus atoms) are replaced with alkyl, branched alkyl, substituted alkyl, alkyl ethers, substituted alkyl ethers, alkyl-aryl, alkyl-substituted aryl, aryl, substituted aryl, and combinations thereof. In another embodiment, phosphorus compounds useful in the invention, include but are not limited to, the above described compounds wherein at least one of the hydrogen atoms bonded to an oxygen atom of the compound is replaced with a metallic ion or an ammonium ion.

The esters can contain alkyl, branched alkyl, substituted alkyl, alkyl ethers, aryl, and/or substituted aryl groups. The esters can also have at least one alkyl group and at least one aryl group. The number of ester groups present in the particular phosphorus compound can vary from zero up to the maximum allowable based on the number of hydroxyl groups present on the phosphorus compound used. For example, an alkyl phosphate ester can include one or more of the mono-, di-, and tri alkyl phosphate esters; an aryl phosphate ester includes one or more of the mono-, di-, and tri aryl phosphate esters; and an alkyl phosphate ester and/or an aryl phosphate ester also include, but are not limited to, mixed alkyl aryl phosphate esters having at least one alkyl and one aryl group.

In one embodiment, the phosphorus compounds useful in the invention include but are not limited to alkyl, aryl or mixed alkyl aryl esters or partial esters of phosphoric acid, phosphorus acid, phosphinic acid, phosphonic acid, or phosphonous acid. The alkyl or aryl groups can contain one or more substituents.

In one embodiment, the phosphorus compounds useful in the invention comprise at least one phosphorus compound chosen from at least one of substituted or unsubstituted alkyl phosphate esters, substituted or unsubstituted aryl phosphate esters, substituted or unsubstituted mixed alkyl aryl phosphate esters, diphosphites, salts of phosphoric acid, phosphine oxides, and mixed aryl alkyl phosphites, reaction products thereof, and combinations thereof. The phosphate esters include esters in which the phosphoric acid is fully esterified or only partially esterified.

In one embodiment, for example, the phosphorus compounds useful in the invention can include at least one phosphate ester.

In one embodiment, the phosphorus compounds useful in the invention comprise at least one phosphorus compound chosen from at least one of substituted or unsubstituted alkyl phosphate esters, substituted or unsubstituted aryl phosphate esters, substituted or unsubstituted mixed alkyl aryl phosphate esters, reaction products thereof, and combinations thereof. The phosphate esters include esters in which the phosphoric acid is fully esterified or only partially esterified.

In one embodiment, for example, the phosphorus compounds useful in the invention can include at least one phosphate ester.

In another embodiment, the phosphate esters useful in the invention can include but are not limited to alkyl phosphate esters, aryl phosphate esters, mixed alkyl aryl phosphate esters, and/or combinations thereof.

In certain embodiments, the phosphate esters useful in the invention are those where the groups on the phosphate ester include are alkyl, alkoxy-alkyl, phenyl, or substituted phenyl groups. These phosphate esters are generally referred to herein as alkyl and/or aryl phosphate esters. Certain preferred embodiments include trialkyl phosphates, triaryl phosphates, alkyl diaryl phosphates, dialkyl aryl phosphates, and combinations of such phosphates, wherein the alkyl groups are preferably those containing from 2 to 12 carbon atoms, and the aryl groups are preferably phenyl.

Representative alkyl and branched alkyl groups are preferably those containing from 1-12 carbon atoms, including, but not limited to, ethyl, propyl, isopropyl, butyl, hexyl, cyclohexyl, 2-ethylhexyl, octyl, decyl and dodecyl. Substituted alkyl groups include, but are not limited to, those containing at least one of carboxylic acid groups and esters thereof, hydroxyl groups, amino groups, keto groups, and the like.

Representative of alkyl-aryl and substituted alkyl-aryl groups are those wherein the alkyl portion contains from 1-12 carbon atoms, and the aryl group is phenyl or substituted phenyl wherein groups such as alkyl, branched alkyl, aryl, hydroxyl, and the like are substituted for hydrogen at any carbon position on the phenyl ring. Preferred aryl groups include phenyl or substituted phenyl wherein groups such as alkyl, branched alkyl, aryl, hydroxyl and the like are substituted for hydrogen at any position on the phenyl ring.

In one embodiment, the phosphate esters useful in the invention include but are not limited to dibutylphenyl phosphate, triphenyl phosphate, tricresyl phosphate, tributyl phosphate, tri-2-ethylhexyl phosphate, trioctyl phosphate, and/or combinations thereof, including particularly combinations of tributyl phosphate and tricresyl phosphate, and combinations of isocetyl diphenyl phosphate and 2-ethylhexyl diphenyl phosphate.

In one embodiment, at least one phosphorus compound useful in the invention comprises at least one aryl phosphate ester.

In one embodiment, at least one phosphorus compound useful in the invention comprises at least one unsubstituted aryl phosphate ester.

In one embodiment, at least one phosphorus compound useful in the invention comprises at least one aryl phosphate ester which is not substituted with benzyl groups.

In one embodiment, any of the phosphorus compounds useful in the invention may comprise at least one alkyl phosphate ester.

In one embodiment, the phosphate esters useful in the invention as thermal stabilizers and/or color stabilizers include but are not limited to, at least one of the following: trialkyl phosphates, triaryl phosphates, alkyl diaryl phosphates, and mixed alkyl aryl phosphates.

In one embodiment, the phosphate esters useful in the invention as thermal stabilizers and/or color stabilizers include but are not limited to, at least one of the following: triaryl phosphates, alkyl diaryl phosphates, and mixed alkyl aryl phosphates.

In one embodiment, the phosphate esters useful as thermal stabilizers and/or color stabilizers in the invention can include but are not limited to, at least one of the following: triaryl phosphates and mixed alkyl aryl phosphates.

In one embodiment, at least one phosphorus compound useful in the invention can comprise, but is not limited to, triaryl phosphates, such as, for example, triphenyl phosphate. In one embodiment, at least one thermal stabilizer comprises, but is not limited to Merpol A. In one embodiment, at least one thermal stabilizer useful in the invention comprises, but is not limited to, at least one of triphenyl phosphate and Merpol A. Merpol A is a phosphate ester commercially available from Stepan Chemical Co and/or E.I. duPont de Nemours & Co. The CAS Registry number for Merpol A is believed to be CAS Registry #37208-27-8.

In one embodiment, any of the phosphorus compounds useful in the invention may comprise at least one triaryl phosphate ester which is not substituted with benzyl groups.

In one embodiment, the polyester compositions and/or processes of the invention may comprise 2-ethylhexyl diphenyl phosphate.

In one embodiment, any of the processes described herein for making any of the polyester compositions and/or polyesters can comprise at least one mixed alkyl aryl phosphite, such as, for example, bis(2,4-dicumylphenyl) pentaerythritol diphosphite also known as Doverphos S-9228 (Dover Chemicals, CAS #15486243-8).

In one embodiment, any of the processes described herein for making any of the polyester compositions and/or polyesters can comprise at least one phosphine oxide.

In one embodiment, any of the processes described herein for making any of the polyester compositions and/or polyesters can comprise at least one salt of phosphoric acid such as, for example, KH2PO4 and Zn3(PO4)2.

The term “thermal stabilizer” is intended to include the reaction product(s) thereof. The term “reaction product” as used in connection with the thermal stabilizers of the invention refers to any product of a polycondensation or esterification reaction between the thermal stabilizer and any of the monomers used in making the polyester as well as the product of a polycondensation or esterification reaction between the catalyst and any other type of additive.

In one embodiment of the invention, the phosphorus compounds useful in the invention may act as thermal stabilizers. In one embodiment of the invention, the phosphorus compounds useful in the invention may not act as a thermal stabilizer but may act as a color stabilizer. In one embodiment of the invention, the phosphorus compounds useful in the invention may act as both a thermal stabilizer and a color stabilizer.

In one embodiment, amounts of the phosphate ester of the invention added during polymerization are chosen from the following: 10 to 200 ppm based on the total weight of the polyester composition and as measured in the form of phosphorus atoms in the final polyester. In embodiments of the invention, phosphorous can be present in an amount of 10 to 100, or 10 to 80, or 10 to 60, or 10 to 55, or 15 to 55, or 18 to 52, or 20 to 50 ppm, based on the total weight of the polyester composition and as measured in the form of phosphorus atoms in the final polyester.

In one embodiment, certain polyesters useful in this invention can be visually clear. The term “visually clear” is defined herein as an appreciable absence of cloudiness, haziness, and/or muddiness, when inspected visually.

In one embodiment, the polyesters and/or polyester compositions of the invention, [in one embodiment, in the presence of and/or in the absence of toner(s)], can have color values L*, a* and b* which can be determined using a Hunter Lab Ultrascan Spectra Colorimeter manufactured by Hunter Associates Lab Inc., Reston, Va. The color determinations are averages of values measured on either pellets of the polyesters or plaques or other items injection molded or extruded from them. They are determined by the L*a*b* color system of the CIE (International Commission on Illumination) (translated), wherein L* represents the lightness coordinate, a* represents the red/green coordinate, and b* represents the yellow/blue coordinate.

In one embodiment, the polyesters or polyester compositions of the invention can have a b* value of from −10 to less than 20, −10 to less than 10, or from 1 to less than 20, or from 5 to less than 20, or from 8 to less than 20, or from −3 to 10, or from −5 to 5, or from −5 to 4, or from −5 to 3, or from 1 to 15, or from 1 to 14, or from 1 to 13, or from 1 to 12, or from 1 to 11, or from 1 to 10, or from 1 to 9, or from 1 to 8, from 1 to 7, or from 1 to 6, or from 1 to 5, or less than 20, or less than 15, or less than 10, or less than 9, or less than 8, or less than 7, or less than 6, or less than 5, or less than 4, or less than 3, as determined by the L*a*b* color system of the CIE (International Commission on Illumination).

In one embodiment, the polyesters or polyester compositions of the invention can have a L* value of from 50 to 99, or from 50 to 90, or from 60 to 99, or from 60 to 90, or from 60 to 85, or from 60 to 80, or from 65 to 99, or from 65 to 90, or from 65 to 85, or from 65 to 80, or from 65 to 75, or from 70 to 90, or from 70 to 99, or from 70 to 90, or from 70 to 85, or from 70 to 80, or from 75 to 95, or from 75 to 90, or from 75 to 85, or from 80 to 90, as determined by the L*a*b* color system of the CIE (International Commission on Illumination).

In one embodiment, the catalyst system contains at least one lithium compound. In one embodiment, the lithium compound can be used in either the esterification reaction or the polycondensation reaction or both reactions. In one embodiment, the catalyst system contains at least one lithium compound used in the esterification reaction. In one embodiment, the catalyst system contains at least one lithium compound used in the polycondensation reaction.

In one embodiment, the catalyst system contains at least one aluminum compound. In one embodiment, the aluminum compound can be used in either the esterification reaction or the polycondensation reaction or both reactions. In one embodiment, the catalyst system contains at least one aluminum compound used in the esterification reaction. In one embodiment, the catalyst system contains at least one aluminum compound used in the polycondensation reaction.

During any of these phases, at any time, the lithium and aluminum compounds can be added separately or in combination.

In one embodiment, the polyesters and/or polyester compositions of the invention can comprise lithium atoms and aluminum atoms.

In one embodiment, at least one lithium source can be selected from lithium carbonate, lithium acetate, lithium benzoate, lithium succinate, lithium acetylacetonate, lithium methoxide, lithium oxalate, lithium nitrate, lithium ethoxide, lithium hydroxide, lithium hydride, lithium glycoxide, alkyl lithium, lithium aluminum hydride, lithium borohydride, and/or lithium oxide.

In one embodiment, at least one lithium source can be lithium acetylacetonate.

In one embodiment, the lithium atoms can be present in the amount of from 5 to 300 ppm, or from 5 to 250 ppm, or from 5 to 200 ppm, or from 5 to 150 ppm, or from 5 to 140 ppm, or from 5 to 130 ppm, or from 5 to 120 ppm, or from 5 to 115 ppm, or from 5 to 110 ppm, or from 10 to 300 ppm, or from 10 to 250 ppm or from 10 to 200 ppm, or from 10 to 150 ppm, or from 10 to 140 ppm, or from 10 to 130 ppm, or from 10 to 120 ppm, or from 10 to 115 ppm, or from 10 to 110 ppm, or from 15 to 300 ppm, or from 15 to 250 ppm, or from 15 to 200 ppm, or from 15 to 150 ppm, or from 15 to 140 ppm, or from 15 to 130 ppm, or from 15 to 120 ppm, or from 15 to 115 ppm, or from 15 to 110 ppm, or from 20 to 300 ppm, or from 20 to 250 ppm, or from 20 to 200 ppm, or from 20 to 150 ppm, or from 20 to 140 ppm, or from 20 to 130 ppm, or from 20 to 120 ppm, or from 20 to 115 ppm, or from 20 to 110 ppm, or from 25 to 300 ppm, or from 25 to 250 ppm, or from 25 to 200 ppm, or from 25 to 150 ppm, or from 25 to 140 ppm, or from 25 to 130 ppm, or from 25 to 120 ppm, or from 25 to 115 ppm, or from 25 to 110 ppm, or from 30 to 300 ppm, or from 30 to 250 ppm, or from 30 to 200 ppm, or from 30 to 150 ppm, or from 30 to 140 ppm, or from 30 to 130 ppm, or from 30 to 120 ppm, or from 30 to 115 ppm, or from 30 to 110 ppm, or from 35 to 300 ppm, or from 35 to 250 ppm, or from 35 to 200 ppm, or from 35 to 150 ppm, or from 35 to 110 ppm, or from 40 to 300 ppm, or from 40 to 250 ppm, or from 40 to 200 ppm, or from 40 to 150 ppm, or from 40 to 140 ppm, or from 40 to 130 ppm, or from 40 to 120 ppm, or from 40 to 115 ppm, or from 40 to 110 ppm, relative to the mass of final polyester being prepared.

In one embodiment, the lithium atoms can be present in the amount of from 20 to 150 ppm, or from 20 to 140 ppm, or from 20 to 130 ppm, or from 20 to 120 ppm, or from 20 to 115 ppm, or from 20 to 110 ppm, or from 20 to 105 ppm, or from 20 to 100 ppm, or from 20 to 95 ppm, or from 20 to 90 ppm, or from 20 to 85 ppm, or from 20 to 80 ppm, or from 25 to 150 ppm, or from 25 to 140 ppm, or from 25 to 130 ppm, or from 25 to 120 ppm, or from 25 to 115 ppm, or from 25 to 110 ppm, or from 25 to 105 ppm, or from 25 to 100 ppm, or from 25 to 95 ppm, or from 25 to 90 ppm, or from 25 to 85 ppm, or from 25 to 80 ppm, or from 30 to 150 ppm, or from 30 to 140 ppm, or from 30 to 130 ppm, or from 30 to 120 ppm, or from 30 to 115 ppm, or from 30 to 110 ppm, or from 30 to 105 ppm, or from 30 to 100 ppm, or from 30 to 95 ppm, or from 30 to 90 ppm, or from 30 to 85 ppm, or from 30 to 80 ppm, or from 35 to 150 ppm, or from 35 to 110 ppm, relative to the mass of final polyester being prepared.

In one embodiment, at least one aluminum source can be selected from aluminum acetate, aluminum benzoate, aluminum sulfate, aluminum lactate, aluminum laurate, aluminum stearate, aluminum alcoholates, aluminum ethylate, aluminum isopropoxide, aluminum trin-butyrate, aluminum tri-tert-butyrate, mono-sec-butoxyaluminum diisopropylate, and aluminum chelates, which the alkoxy group of an aluminum alcoholate is partially or wholly substituted by a chelating agent such as an alkyl acetoacetate or acetylacetone, such as ethyl acetoacetate aluminum diisopropylate, aluminum tris(ethyl acetoacetate), alkyl acetoacetate, aluminum diisopropylate, aluminum monoacetylacetate bis(ethyl acetoacetate), aluminum tris(acetyl acetate), or aluminum acetylacetonate.

In one embodiment, at least one aluminum source can be selected from aluminum hydroxide, aluminum acetylacetonate, aluminum acetate, aluminum isopropoxide or aluminum sulfate.

In one embodiment, at least one aluminum source can be selected from aluminum acetylacetonate and aluminum isopropoxide.

In one embodiment, the polyesters and/or polyester compositions of the invention can comprise aluminum atoms in the amount of from 5 to 300 ppm, or from 5 to 275 ppm, or from 5 to 250 ppm, or from 5 to 200 ppm, or from 5 to 150 ppm, or from 5 to 140 ppm, or from 5 to 135 ppm, or from 5 to 130 ppm, or from 5 to 120 ppm, or from 5 to 115 ppm, or from 5 to 110 ppm, or from 10 to 300 ppm, or from 10 to 275 ppm, or from 10 to 250 ppm or from 10 to 200 ppm, or from 10 to 175 ppm, or from 10 to 150 ppm, or from 10 to 140 ppm, or from 10 to 135 ppm, or from 10 to 130 ppm, or from 10 to 120 ppm, or from 10 to 115 ppm, or from 10 to 110 ppm, or from 15 to 300 ppm, or from 15 to 275 ppm, or from 15 to 250 ppm, or from 15 to 200 ppm, or from 15 to 175 ppm, or from 15 to 150 ppm, or from 15 to 140 ppm, or from 15 to 130 ppm, or from 15 to 135 ppm, or from 15 to 120 ppm, or from 15 to 115 ppm, or from 15 to 110 ppm, or from 20 to 300 ppm, or from 20 to 275 ppm, or from 20 to 250 ppm, or from 20 to 200 ppm, or from 20 to 175 ppm, or from 20 to 150 ppm, or from 20 to 140 ppm, or from 20 to 135 ppm, or from 20 to 130 ppm, or from 20 to 120 ppm, or from 20 to 115 ppm, or from 20 to 110 ppm, or from 25 to 300 ppm, or from 25 to 275 ppm, or from 25 to 250 ppm, or from 25 to 200 ppm, or from 25 to 175 ppm, or from 25 to 150 ppm, or from 25 to 140 ppm, or from 25 to 135 ppm, or from 25 to 130 ppm, or from 25 to 120 ppm, or from 25 to 115 ppm, or from 25 to 110 ppm, or from 30 to 300 ppm, or from 30 to 275 ppm, or from 30 to 250 ppm, or from 30 to 200 ppm, or from 30 to 150 ppm, or from 30 to 140 ppm, or from 30 to 135 ppm, or from 30 to 130 ppm, or from 30 to 120 ppm, or from 30 to 115 ppm, or from 30 to 110 ppm, or from 35 to 300 ppm, or from 35 to 275 ppm, or from 35 to 250 ppm, or from 35 to 200 ppm, or from 35 to 150 ppm, or from 35 to 140 ppm, or from 35 to 135 ppm, or from 35 to 130 ppm, or from 35 to 120 ppm, or from 35 to 115 ppm, or from 35 to 110 ppm, or from 40 to 300 ppm, or from 40 to 275 ppm, or from 40 to 250 ppm, or from 40 to 200 ppm, or from 40 to 150 ppm, or from 40 to 140 ppm, or from 40 to 135 ppm, or 25 from 40 to 130 ppm, or from 40 to 120 ppm, or from 40 to 115 ppm, or from 40 to 110 ppm, relative to the mass of final polyester being prepared.

In one embodiment, the polyesters and/or polyester compositions of the invention can comprise aluminum atoms in the amount of from 5 to 300 ppm, or from 5 to 275 ppm, or from 5 to 250 ppm, or from 5 to 200 ppm, or from 5 to 150 ppm, or from 5 to 140 ppm, or from 5 to 135 ppm, or from 5 to 130 ppm, or from 5 to 120 ppm, or from 5 to 115 ppm, or from 5 to 110 ppm, or from 10 to 300 ppm, or from 10 to 275 ppm, or from 10 to 250 ppm or from 10 to 200 ppm, or from 10 to 175 ppm, or from 10 to 150 ppm, or from 10 to 140 ppm, or from 10 to 135 ppm, or from 10 to 130 ppm, or from 10 to 120 ppm, or from 10 to 115 ppm, or from 10 to 110 ppm, or from 15 to 300 ppm, or from 15 to 275 ppm, or from 15 to 250 ppm, or from 15 to 200 ppm, or from 15 to 175 ppm, or from 15 to 150 ppm, or from 15 to 140 ppm, or from 15 to 130 ppm, or from 15 to 135 ppm, or from 15 to 120 ppm, or from 15 to 115 ppm, or from 15 to 110 ppm, or from 20 to 300 ppm, or from 20 to 275 ppm, or from 20 to 250 ppm, or from 20 to 200 ppm, or from 20 to 175 ppm, or from 20 to 150 ppm, or from 20 to 140 ppm, or from 20 to 135 ppm, or from 20 to 130 ppm, or from 20 to 120 ppm, or from 20 to 115 ppm, or from 20 to 110 ppm, or from 30 to 300 ppm, or from 30 to 275 ppm, or from 30 to 250 ppm, or from 30 to 200 ppm, or from 30 to 175 ppm, or from 30 to 160 ppm, or from 30 to 155 ppm, or from 30 to 150 ppm, or from 30 to 140 ppm, or from 30 to 135 ppm, or from 30 to 130 ppm, or from 30 to 120 ppm, or from 30 to 115 ppm, or from 30 to 110 ppm, or from 40 to 300 ppm, or from 40 to 275 ppm, or from 40 to 250 ppm, or from 40 to 200 ppm, or from 40 to 175 ppm, or from 40 to 160 ppm, or from 40 to 155 ppm, or from 40 to 150 ppm, or from 40 to 140 ppm, or from 40 to 135 ppm, or from 40 to 130 ppm, or from 40 to 120 ppm, or from 40 to 115 ppm, or from 40 to 110 ppm, or from 50 to 300 ppm, or from 50 to 275 ppm, or from 50 to 250 ppm, or from 50 to 200 ppm, or from 50 to 175 ppm, or from 50 to 160 ppm, or from 50 to 155 ppm, or from 50 to 150 ppm, or from 50 to 140 ppm, or from 50 to 135 ppm, or from 50 to 130 ppm, or from 50 to 120 ppm, or from 50 to 115 ppm, or from 50 to 110 ppm, or from 60 to 300 ppm, or from 60 to 275 ppm, or from 60 to 250 ppm, or from 60 to 200 ppm, or from 60 to 175 ppm, or from 60 to 160 ppm, or from 60 to 155 ppm, or from 60 to 150 ppm, or from 60 to 140 ppm, or from 60 to 135 ppm, or from 60 to 130 ppm, or from 60 to 120 ppm, or from 60 to 115 ppm, or from 60 to 110 ppm, relative to the mass of final polyester being prepared.

In one embodiment, the polyesters and/or polyester compositions of the invention can comprise a ratio of lithium atoms to aluminum atoms in ppm relative to the mass of final polyester being prepared from 1:5 to 5:1, or from 1:4 to 4:1, or from 1:3 to 3:1, or from 1:2 to 2:1, or from 1:4 to 1:0.25, or from 1:3 to 1:0.25, or from 1:1.25 to 1.0:0.25.

In one embodiment, the polyesters and/or polyester compositions of the invention can comprise a total of catalyst metal atoms in the amount of from 10 to 600 ppm, 20 to 500 ppm, or from 10 to 400 ppm, or from 10 to 350 ppm, or from 10 to 300 ppm, or from 10 to 250 ppm, or from 20 to 600 ppm, 20 to 500 ppm, or from 20 to 400 ppm, or from 20 to 350 ppm, or from 20 to 300 ppm, or from 20 to 250 ppm, or 40 to 600 ppm, or 40 to 500 ppm, or from 40 to 400 ppm, or from 40 to 350, or from 40 to 300 ppm, or from 40 to 250 ppm, or from 50 to 600 ppm, or from 50 to 500 ppm, or from 50 to 400 ppm, or from 50 to 250 ppm, or from 60 to 600 ppm, or from 60 to 500 ppm, or from 60 to 400 ppm, or from 60 to 300 ppm, or from 60 to 250 ppm, or from 70 to 600 ppm, or from 70 to 500 ppm, or from 70 to 400 ppm, or from 70 to 350 ppm, or from 70 to 300 ppm, or from 70 to 250 ppm, or from 75 to 600 ppm, or from 70 to 500 ppm, or from 75 to 400 ppm, or from 75 to 350 ppm, or from 75 to 300 ppm, or from 75 to 250 ppm, or from 80 to 600 ppm, or from or from 80 to 500 ppm, or from 80 to 400 ppm, or from 80 to 350 ppm, or from 80 to 300 ppm, or from 80 to 250 ppm, or less than 600 ppm, or less than 500 ppm, or less than 400 ppm, or less than 350 ppm, or less than 300 ppm, or less than 250 ppm, relative to the mass of final polyester being prepared.

In one embodiment, the catalyst system contains at least one zirconium compound. In one embodiment, the zirconium compound can be used in either the esterification reaction or the polycondensation reaction or both reactions. In one embodiment, the catalyst system contains at least one zirconium compound used in the esterification reaction. In one embodiment, the catalyst system contains at least one zirconium compound used in the polycondensation reaction.

In one embodiment, the polyesters and/or polyester compositions of the invention can comprise zirconium atoms.

In one embodiment, the polyesters and/or polyester compositions of the invention can comprise at least one zirconium source selected from zirconium esters, phenolates, acylates and chelates.

In one embodiment, the polyesters and/or polyester compositions of the invention can comprise at least one zirconium source selected from zirconium acetylacetoacetate and zirconium n-butoxide.

In one embodiment, the polyesters and/or polyester compositions of the invention can comprise at least one zirconium source selected from zirconium acetylacetonate.

In one embodiment, the polyesters and/or polyester compositions of the invention can comprise zirconium atoms in the amount of from 5 to 600 ppm, or from 5 to 500 ppm, or from 5 to 400 ppm, or from or from 5 to 375 ppm, or from 5 to 350 ppm, or from 5 to 300 ppm, or from 5 to 250 ppm, or from 50 to 600 ppm, or from 50 to 500 ppm, or from 50 to 400 ppm, or from 50 to 375 ppm, or from 50 to 350 ppm, or from 50 to 300 ppm, or from 50 to 250 ppm, or from 50 to 200 ppm, or from 100 to 600 ppm, or from 100 to 500 ppm, or from 100 to 400 ppm, or from 100 to 375 ppm, or from 100 to 350 ppm, or from 100 to 300 ppm, or from 100 to 250 ppm, or from 100 to 200 ppm, or from 150 to 600 ppm, or from 150 to 500 ppm, or from 150 to 400 ppm, or from 150 to 375 ppm, or from 150 to 350 ppm, or from 150 to 300 ppm, or from 150 to 250 ppm, or from 200 to 600 ppm, or from 200 to 500 ppm, or from 200 to 400 ppm, or from 200 to 375 ppm, or from 200 to 350 ppm, relative to the mass of final polyester being prepared.

In one embodiment, the catalyst system contains at least one gallium compound. In one embodiment, the gallium compound can be used in either the esterification reaction or the polycondensation reaction or both reactions. In one embodiment, the catalyst system contains at least one gallium compound used in the esterification reaction. In one embodiment, the catalyst system contains at least one gallium compound used in the polycondensation reaction.

In one embodiment, the polyesters and/or polyester compositions of the invention can comprise gallium atoms.

In one embodiment, the polyesters and/or polyester compositions of the invention can comprise at least one gallium compound with at least one organic substituent.

In one embodiment, the polyesters and/or polyester compositions of the invention can comprise at least one of the carboxylic acid salts of gallium.

In one embodiment, the polyesters and/or polyester compositions of the invention can comprise at least one gallium source selected from gallium acetate, gallium benzoate, gallium sulfate, gallium lactate, gallium laurate, gallium stearate, gallium alcoholates, gallium ethylate, gallium isopropoxide, gallium tri-n-butyrate, gallium tri-tert-butyrate, mono-sec-butoxygallium diisopropylate, and gallium chelates, ethyl acetoacetate gallium diisopropylate, gallium tris(ethyl acetoacetate), gallium alkyl acetoacetate, gallium diisopropylate, gallium monoacetylacetate bis(ethyl acetoacetate), gallium tris(acetyl acetate), or gallium acetylacetonate.

In one embodiment, the polyesters and/or polyester compositions of the invention can comprise at least one gallium compound selected from gallium hydroxide, gallium acetylacetonate, gallium acetate, gallium isopropoxide or gallium sulfate.

In one embodiment, the polyesters and/or polyester compositions of the invention can comprise at least one gallium source selected from gallium acetylacetonate and gallium isopropoxide.

In one embodiment, the polyesters and/or polyester compositions of the invention can comprise at least one gallium source selected from gallium acetylacetonate.

In one embodiment, the polyesters and/or polyester compositions of the invention can comprise gallium atoms in the amount of from 5 to 300 ppm, or from 5 to 275 ppm, or from 5 to 250 ppm, or from 5 to 200 ppm, or from 5 to 150 ppm, or from 5 to 140 ppm, or from 5 to 135 ppm, or from 5 to 130 ppm, or from 5 to 120 ppm, or from 5 to 115 ppm, or from 5 to 110 ppm, or from 10 to 300 ppm, or from 10 to 275 ppm, or from 10 to 250 ppm or from 10 to 200 ppm, or from 10 to 175 ppm, or from 10 to 150 ppm, or from 10 to 140 ppm, or from 10 to 135 ppm, or from 10 to 130 ppm, or from 10 to 120 ppm, or from 10 to 115 ppm, or from 10 to 110 ppm, or from 15 to 300 ppm, or from 15 to 275 ppm, or from 15 to 250 ppm, or from 15 to 200 ppm, or from 15 to 175 ppm, or from 15 to 150 ppm, or from 15 to 140 ppm, or from 15 to 130 ppm, or from 15 to 135 ppm, or from 15 to 120 ppm, or from 15 to 115 ppm, or from 15 to 110 ppm, or from 20 to 300 ppm, or from 20 to 275 ppm, or from 20 to 250 ppm, or from 20 to 200 ppm, or from 20 to 175 ppm, or from 20 to 150 ppm, or from 20 to 140 ppm, or from 20 to 135 ppm, or from 20 to 130 ppm, or from 20 to 120 ppm, or from 20 to 115 ppm, or from 20 to 110 ppm, or from 30 to 300 ppm, or from 30 to 275 ppm, or from 30 to 250 ppm, or from 30 to 200 ppm, or from 30 to 175 ppm, or from 30 to 160 ppm, or from 30 to 155 ppm, or from 30 to 150 ppm, or from 30 to 140 ppm, or from 30 to 135 ppm, or from 30 to 130 ppm, or from 30 to 120 ppm, or from 30 to 115 ppm, or from 30 to 110 ppm, or from 40 to 300 ppm, or from 40 to 275 ppm, or from 40 to 250 ppm, or from 40 to 200 ppm, or from 40 to 175 ppm, or from 40 to 160 ppm, or from 40 to 155 ppm, or from 40 to 150 ppm, or from 40 to 140 ppm, or from 40 to 135 ppm, or from 40 to 130 ppm, or from 40 to 120 ppm, or from 40 to 115 ppm, or from 40 to 110 ppm, or from 50 to 300 ppm, or from 50 to 275 ppm, or from 50 to 250 ppm, or from 50 to 200 ppm, or from 50 to 175 ppm, or from 50 to 160 ppm, or from 50 to 155 ppm, or from 50 to 150 ppm, or from 50 to 140 ppm, or from 50 to 135 ppm, or from 50 to 130 ppm, or from 50 to 120 ppm, or from 50 to 115 ppm, or from 50 to 110 ppm, or from 60 to 300 ppm, or from 60 to 275 ppm, or from 60 to 250 ppm, or from 60 to 200 ppm, or from 60 to 175 ppm, or from 60 to 160 ppm, or from 60 to 155 ppm, or from 60 to 150 ppm, or from 60 to 140 ppm, or from 60 to 135 ppm, or from 60 to 130 ppm, or from 60 to 120 ppm, or from 60 to 115 ppm, or from 60 to 110 ppm, or from 100 to 600 ppm, or from 100 to 500 ppm, or from 100 to 400 ppm, or from 100 to 375 ppm, or from 100 to 350 ppm, or from 100 to 300 ppm, or from 100 to 250 ppm, or from 150 to 600 ppm, or from 150 to 500 ppm, or from 150 to 400 ppm, or from 150 to 375 ppm, or from 150 to 350 ppm, or from 150 to 300 ppm, or from 150 to 250 ppm, or from 200 to 600 ppm, or from 200 to 500 ppm, or from 200 to 400 ppm, or from 200 to 375 ppm, or from 200 to 350 ppm, or from 250 to 600 ppm, or from 250 to 500 ppm, or from 250 to 400 ppm, or from 250 to 375 ppm, or from 250 to 350 ppm, relative to the mass of final polyester being prepared.

In one embodiment, the polyesters and/or polyester compositions of the invention can comprise titanium atoms in an amount of less than 30 ppm, or less than 20 ppm, or less than 10 ppm, or less than 5 ppm, or from 0 to 30 ppm, or from 0 to 20 ppm, or from 0 to 10 ppm, or 0 ppm, relative to the mass of final polyester being prepared.

In certain embodiments, additional catalysts could possibly be used in the catalyst systems of the invention or the catalyst systems of the invention can be limited to those catalysts described as part of the invention. In the case where at least one lithium compound and at least one aluminum compound are used, other catalysts may include, but are not limited to, such as those based on gallium, titanium, zirconium, zinc, antimony, cobalt, magnesium, manganese, germanium. In the case where at least one gallium compound is used, other catalysts may include, but are not limited to, such as those based on lithium, aluminum, zirconium, titanium, zinc, antimony, cobalt, magnesium, manganese, germanium. In the case where at least one zirconium compound is used, other catalysts may include, but are not limited to, such as those based on lithium, aluminum, gallium, zinc, antimony, titanium, cobalt, magnesium, manganese, germanium.

In one embodiment, the polyesters and/or polyester compositions of the invention can comprise tin atoms in an amount of less than 30 ppm, or less than 20 ppm, or less than 10 ppm, or less than 5 ppm, or from 0 to 30 ppm, or from 0 to 20 ppm, or from 0 to 10 ppm, or 0 ppm, relative to the mass of final polyester being prepared.

In one embodiment, the polyesters and/or polyester compositions of the invention can comprise manganese atoms in an amount of less than 30 ppm, or less than 20 ppm, or less than 10 ppm, or less than 5 ppm, or from 0 to 30 ppm, or from 0 to 20 ppm, or from 0 to 10 ppm, or 0 ppm, relative to the mass of final polyester being prepared.

In one embodiment, the polyesters and/or polyester compositions of the invention can comprise zinc atoms in an amount of less than 30 ppm, or less than 20 ppm, or less than 10 ppm, or less than 5 ppm, or from 0 to 30 ppm, or from 0 to 20 ppm, or from 0 to 10 ppm, or 0 ppm, relative to the mass of final polyester being prepared.

In one embodiment, the polyesters and/or polyester compositions of the invention can comprise titanium atoms in an amount of less than 30 ppm, or less than 20 ppm, or less than 10 ppm, or less than 5 ppm, or from 0 to 30 ppm, or from 0 to 20 ppm, or from 0 to 10 ppm, or 0 ppm, relative to the mass of final polyester being prepared.

In one embodiment, the polyesters and/or polyester compositions of the invention can comprise less than 30 ppm, or less than 20 ppm, or less than 10 ppm, or less than 5 ppm, or from 0 to 30 ppm, or from 0 to 20 ppm, or from 0 to 10 ppm, or 0 ppm, of titanium atoms, tin atoms, or any combinations thereof, in an amount of relative to the mass of final polyester being prepared.

In one embodiment, the polyesters and/or polyester compositions of the invention can comprise less than 30 ppm, or less than 20 ppm, or less than 10 ppm, or less than 5 ppm, or from 0 to 30 ppm, or from 0 to 20 ppm, or from 0 to 10 ppm, or 0 ppm, of titanium atoms, tin atoms, zinc atoms, or any combinations thereof, in an amount of relative to the mass of final polyester being prepared.

In one embodiment, the polyesters and/or polyester compositions of the invention can comprise less than 30 ppm, or less than 20 ppm, or less than 10 ppm, or less than 5 ppm, or from 0 to 30 ppm, or from 0 to 20 ppm, or from 0 to 10 ppm, or 0 ppm, of titanium atoms, tin atoms, manganese atoms, zinc atoms, or any combinations thereof, in an amount of relative to the mass of final polyester being prepared.

In one embodiment, the polyesters or polyester compositions of the invention can have a final acid number (AN) of up to 10.

In one embodiment, the polyesters or polyester compositions of the invention can have a final hydroxyl number up to 35 mg KOH/g of polymer.

In one embodiment, the polyesters or polyester compositions of the invention can comprise a blend with at least one polymer chosen from at least one of the following: polyesters other than those in aspect 1 or other aspects referring to aspect 1 of the Summary of the Invention, poly(etherimides), polyphenylene oxides, poly(phenylene oxide)/polystyrene blends, polystyrene resins, polyphenylene sulfides, polyphenylene sulfide/sulfones, poly(ester-carbonates), polycarbonates, polysulfones; polysulfone ethers, and poly(ether-ketones).

In one embodiment, the polyesters or polyester compositions of the invention can be a blend of the polyesters or polyester compositions of the invention with recycled poly(ethylene terephthalate)(rPET).

In one embodiment, in the polyesters or polyester compositions of the invention, the extent of 2,2,4,4-tetramethyl-1,3-cyclobutanediol incorporation or conversion in the final polymer can be greater than 55 mole %, or greater than 50 mole %, or greater than 45 mole %, or greater than 40 mole %, or greater than 35 mole %, or greater than 30 mole %.

In one embodiment, the polyesters or polyester compositions of the invention can be made by any processes known in the art.

In one embodiment, the esterification catalyst(s) can be added after the start of the esterification to make the polyesters or polyester compositions of the invention.

In one embodiment, the esterification catalyst(s) can be added after the start of the esterification and prior to pulling vacuum to make the polyesters or polyester compositions of the invention.

In one embodiment, the esterification catalyst(s) can be added after the start of the esterification and from 0 to 40, or 0 to 35, or 0 to 30, or 0 to 25, or 0 to 20, or 0 to 15, or 1 to 40, or 1 to 35, or 1 to 30, or 1 to 25, or 1 to 20, or 1 to 15, or 5 to 40, or 5 to 35, or 5 to 30, or 5 to 25, or 5 to 20, or 5 to 15, or 10 to 40, or 10 to 35, or 10 to 30, or 10 to 25, or 10 to 20, or 10 to 15, or 15 to 40, or 15 to 35, or 15 to 30, or 15 to 25 minutes, or 15 to 20 minutes prior to pulling vacuum to make the polyesters or polyester compositions of the invention.

In one embodiment, the esterification catalyst(s) can be added after the start of the esterification and from 10 to 30, or 15 to 30, or 15 to 25 minutes, or 15 to 20 minutes prior to pulling vacuum to make the polyesters or polyester compositions of the invention.

In one embodiment, at least one zirconium catalyst, or at least one gallium catalyst, or at least one lithium/aluminum catalyst is added to the esterification when the polyol has an acid number of from 1 to 40, or 1 to 35, or 1 to 30, or 1 to 25, or 1 to 20, or 1 to 15, or 5 to 40, or 5 to 35, or 5 to 30, or 5 to 25, or 5 to 20, or 5 to 15, or 10 to 40, or 10 to 35, or 10 to 30, or 10 to 25, or 10 to 20, or 10 to 15, or 15 to 40, or 15 to 35, or 15 to 30, or 15 to 25 mg KOH/g polymer to make the polyesters or polyester compositions of the invention.

In one embodiment, at least one zirconium catalyst, or at least one gallium catalyst, or at least one lithium/aluminum catalyst is added to the esterification when the polyol has an acid number of from 10 to 30, or from 10 to 25, or from 15 to 25 mg KOH/g polymer to make the polyesters or polyester compositions of the invention.

In one embodiment, at least one zirconium catalyst, or at least one gallium catalyst, or at least one lithium/aluminum catalyst is added to the esterification when the polyol/polyester has an acid number of from 15 to 25 mg KOH/g polymer to make the polyesters or polyester compositions of the invention.

The polyesters, polyols, or polyester compositions of the invention can include any catalyst or catalyst system described herein.

In certain embodiments of the invention, the Tg of the polyesters can be from 40-110° C. The glass transition temperature (Tg) of the polyesters is determined using a TA DSC 2920 from Thermal Analyst Instrument at a scan rate of 20° C./min.

It is contemplated that compositions useful in the invention can possess at least one of the inherent viscosity ranges described herein and at least one of the monomer ranges for the compositions described herein unless otherwise stated. It is also contemplated that compositions useful in the invention can possess at least one of the Tg ranges described herein and at least one of the monomer ranges for the compositions described herein unless otherwise stated. It is also contemplated that compositions useful in the invention can possess at least one of the inherent viscosity ranges described herein, at least one of the Tg ranges described herein, and at least one of the monomer ranges for the compositions described herein unless otherwise stated.

The polyester portion of the polyester compositions useful in the invention can be made by processes known from the literature such as, for example, by processes in homogenous solution, by transesterification processes in the melt, and by two phase interfacial processes. Suitable methods include, but are not limited to, the steps of reacting one or more dicarboxylic acids with one or more glycols at a temperature of 100° C. to 315° C. at a pressure of 0.1 to 760 mm Hg for a time sufficient to form a polyester. See U.S. Pat. No. 3,772,405 for methods of producing polyesters, the disclosure regarding such methods is hereby incorporated herein by reference.

The polyester in general may be prepared by condensing the dicarboxylic acid or dicarboxylic acid ester with the glycol in the presence of the lithium catalyst(s) and aluminum(s) (and optionally, other catalysts), as described herein, at elevated temperatures increased gradually during the course of the condensation up to a temperature of about 225°−310° C., in an inert atmosphere, and conducting the condensation at low pressure during the latter part of the condensation, as described in further detail in U.S. Pat. No. 2,720,507 incorporated herein by reference.

In another embodiment, this invention relates to a process for preparing copolyesters of the invention. In one embodiment, the process relates to preparing copolyesters comprising the steps of:
(A) heating a mixture comprising the monomers useful in the polyesters of the invention in the presence of at least one catalyst at a temperature of 150 to 250° C. for a time sufficient to produce an initial polyester;
(B) polycondensing the product of Step (A) by heating it at a temperature of 230 to 320° C. for 1 to 6 hours; and
(C) removing any unreacted glycols.

Reaction times for the esterification Step (A) are dependent upon the selected temperatures, pressures, and feed mole ratios of glycol to dicarboxylic acid.

In one embodiment, although not intended to be limiting, step (A) can be carried out until 50% by weight or more of the TMCD has been reacted. Also, step (A) may be carried out under pressure, ranging from 0 psig to 100 psig. The term “reaction product” as used in connection with any of the catalysts useful in the invention refers to any product of a polycondensation or esterification reaction with the catalyst and any of the monomers used in making the polyester as well as the product of a polycondensation or esterification reaction between the catalyst and any other type of additive.

In certain embodiments, Step (B) and Step (C) may or may not be conducted at the same time. These steps can be carried out by methods known in the art such as by placing the reaction combination under a pressure ranging, from 0.002 psig to below atmospheric pressure, or by blowing hot nitrogen gas over the combination.

In one embodiment, the pressure used in Step (II) of any of the processes of the invention can consist of at least one pressure chosen from 20 torr absolute to 0.02 torr absolute; in one embodiment, the pressure used in Step (II) of any of the processes of the invention can consist of at least one pressure chosen from 10 torr absolute to 0.02 torr absolute; in one embodiment, the pressure used in Step (II) of any of the processes of the invention can consist of at least one pressure chosen from 5 torr absolute to 0.02 torr absolute; in one embodiment, the pressure used in Step (II) of any of the processes of the invention can consist of at least one pressure chosen from 3 torr absolute to 0.02 torr absolute; in one embodiment, the pressure used in Step (II) of any of the processes of the invention can consist of at least one pressure chosen from 20 torr absolute to 0.1 torr absolute; in one embodiment, the pressure used in Step (II) of any of the processes of the invention can consist of at least one pressure chosen from 10 torr absolute to 0.1 torr absolute; in one embodiment, the pressure used in Step (II) of any of the processes of the invention can consist of at least one pressure chosen from 5 torr absolute to 0.1 torr absolute; in one embodiment, the pressure used in Step (II) of any of the processes of the invention can consist of at least one pressure chosen from 3 torr absolute to 0.1 torr absolute.

In one embodiment, the molar ratio of glycol component/dicarboxylic acid component added in Step (I) of a process of the invention is 1.0-2.0/1.0; in one embodiment, the molar ratio of glycol component/dicarboxylic acid component added in Step (I) of a process of the invention is 1.01-2.0/1.0; in one embodiment, the molar ratio of glycol component/dicarboxylic acid component added in Step (I) of a process of the invention is 1.01-1.75/1.0; in one embodiment, the molar ratio of glycol component/dicarboxylic acid component added in Step (I) of a process of the invention is 1.01-1.7/1.0; in one embodiment, the molar ratio of glycol component/dicarboxylic acid component added in Step (I) of a process of the invention is 1.01-1.5/1.0; in one embodiment, the molar ratio of glycol component/dicarboxylic acid component added in Step (I) of a process of the invention is 1.01-1.2/1.0.

In embodiments of the invention for the process for making the polyesters, the heating time of Step (II) may be from 1 to 5 hours or 1 to 4 hours or 1 to 3 hours or 1.5 to 3 hours or 1 to 2 hours. In one embodiment, the heating time of Step (II) can be from 1.5 to 3 hours.

In one embodiment, the processes of making the polyesters of the invention can comprise a batch or continuous process.

In one embodiment, the processes of making the polyesters of the invention comprise a continuous process.

In embodiments of the invention, certain agents which colorize the polymer can be added to the melt. In one embodiment, a bluing toner is added to the melt in order to reduce the b* of the resulting polyester polymer melt phase product. Such bluing agents include blue inorganic and organic toner(s). In addition, red toner(s) can also be used to adjust the a* color. Organic toner(s), e.g., blue and red organic toner(s), such as those toner(s) described in U.S. Pat. Nos. 5,372,864 and 5,384,377, which are incorporated by reference in their entirety, can be used. The organic toner(s) can be fed as a premix composition. The premix composition may be a neat blend of the red and blue compounds or the composition may be pre-dissolved or slurried in one of the polyester's raw materials, e.g., ethylene glycol.

The total amount of toner components added can depend on the amount of inherent yellow color in the base polyester and the efficacy of the toner. In one embodiment, a concentration of up to about 15 ppm of combined organic toner components and a minimum concentration of about 0.5 ppm are used. In one embodiment, the total amount of bluing additive can range from 0.5 to 10 ppm. In an embodiment, the toner(s) can be added to the esterification zone or to the polycondensation zone. Preferably, the toner(s) are added to the esterification zone or to the early stages of the polycondensation zone, such as to a prepolymerization reactor.

The invention further relates to a polymer blend. The blend comprises:
(a) from 5 to 95 weight % of at least one of the polyesters described above; and
(b) from 5 to 95 weight % of at least one of the polymeric components.

Suitable examples of the polymeric components include, but are not limited to, nylon; polyesters different than those described herein such as PET; polyamides such as ZYTEL® from DuPont; polystyrene; polystyrene copolymers; styrene acrylonitrile copolymers; acrylonitrile butadiene styrene copolymers; poly(methylmethacrylate); acrylic copolymers; poly(ether-imides) such as ULTEM® (a poly(ether-imide) from General Electric); polyphenylene oxides such as poly(2,6-dimethylphenylene oxide) or poly(phenylene oxide)/polystyrene blends such as NORYL 1000® (a blend of poly(2,6-dimethylphenylene oxide) and polystyrene resins from General Electric); polyphenylene sulfides; polyphenylene sulfide/sulfones; poly(ester-carbonates); polycarbonates such as LEXAN® (a polycarbonate from General Electric); polysulfones; polysulfone ethers; and poly(ether-ketones) of aromatic dihydroxy compounds; or combinations of any of the foregoing polymers. The blends can be prepared by conventional processing techniques known in the art, such as melt blending or solution blending.

In one embodiment, the final polyester compositions of the invention can be blended with recycled poly(ethylene terephthalate)(rPET).

In certain embodiment, the polyester compositions and the polymer blend compositions can also contain from 0.01 to 25% by weight of the overall composition common additives such as colorants, toner(s), dyes, mold release agents, flame retardants, plasticizers, nucleating agents, stabilizers, including but not limited to, UV stabilizers, thermal stabilizers other than the phosphorus compounds describe herein, and/or reaction products thereof, fillers, and impact modifiers. Examples of commercially available impact modifiers include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyester composition.

Reinforcing materials may be added to the compositions of this invention. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials include glass, such as, fibrous glass filaments, combinations of glass and talc, glass and mica, and glass and polymeric fibers

In one embodiment, the invention includes any product made by any of the processes herein.

In one embodiment, the invention includes any article of manufacture made with the polyesters or polyester compositions of the invention.

In one embodiment, the invention includes any shaped article made with the polyesters or polyester compositions of the invention.

In one embodiment, the invention includes any coating composition made with the polyesters or polyester compositions of the invention.

In one embodiment, the polyesters or polyester compositions of the invention can be suitable for applications in coatings, such as automotive, industrial maintenance, and furniture, and in adhesives such as laminating adhesive. The polyester/polyol compositions are especially suitable for field-applied industrial maintenance coatings, automotive refinish coatings, wood coatings, can coatings, coatings for food packaging, and marine craft gelcoats).

In one embodiment, the polyester composition, polyesters, polyols described herein are included within the scope of the invention, whether or not containing the catalyst(s) described therein. By the term “polyester,” polyols are also intended within the scope of the term.

In addition, the processes of the invention have the advantages of effective TMCD incorporation, good TMCD yield, good acid numbers (AN), good hydroxyl numbers (OHN), good inherent viscosities (IV), good number average molecular weight, good clarity (lack of haze), and good color.

The following examples further illustrate how the polyesters of the invention can be made and evaluated and are intended to be purely exemplary of the invention and are not intended to limit the scope thereof. Unless indicated otherwise, parts are parts by weight, temperature is in degrees C. or is at room temperature, and pressure is at or near atmospheric.

### EXAMPLES

The following examples illustrate, in general, how copolyesters of this invention are prepared and the effect of using TMCD and modifying glycols, and certain catalyst and stabilizers, on various copolyester properties such as color and inherent viscosity (IV).

### Measurement Methods

The inherent viscosity of the polyesters was determined in 60/40 (wt/wt) phenol/tetrachloroethane at a concentration of 0.5 g/100 ml at 25° C., and is reported in dL/g.

The glycol content and the cis/trans ratio of the compositions were determined by proton nuclear magnetic resonance (NMR) spectroscopy. All NMR spectra were recorded on a JEOL Eclipse Plus 600 MHz nuclear magnetic resonance spectrometer using either chloroform-trifluoroacetic acid (70-30 volume/volume) for polymers or, for oligomeric samples, 60/40 (wt/wt) phenol/tetrachloroethane with deuterated chloroform added for lock. Peak assignments for TMCD resonances were made by comparison to model mono- and dibenzoate esters of TMCD. These model compounds closely approximate the resonance positions found in the polymers and oligomers.

Color values reported herein are CIELAB L*, a*, and b* values measured following ASTM D 6290-98 and ASTM E308-99, using measurements from a Hunter Lab Ultrascan XE Spectrophotometer (Hunter Associates Laboratory Inc., Reston, Va.) with the following parameters: (1) D65 illuminant, (2) 10 degree observer, (3) reflectance mode with specular angle included, (4) large area view, (5) 1″ port size. Unless stated otherwise, the measurements were performed on polymer granules ground to pass a 1 mm sieve.

The amounts of aluminum (AI), lithium (Li), gallium (Ga), and zirconium (Zr) in the examples below are reported in parts per million (ppm) of metal and were measured by inductively coupled plasma mass spectrometry (ICP).

Unless otherwise specified, the cis/trans ratio of the TMCD used in the following examples was approximately 60/40 and could range from 45/55 to 99/1.

Abbreviations Table - Unless otherwise expressed herein,
the following abbreviations are defined as follows:

| | |
|---|---|
| AN | Acid number (expressed in mg KOH/g polymer) |
| OHN | Hydroxyl number (expressed in mg KOH/g polymer) |
| Mw | Weight average molecular weight |
| Mn | Number average molecular weight |
| Mz | Z-average molecular weight |
| CHDM | 1,4-cyclohexanedimethanol |
| TMCD | 2,2,4,4-tetramethyl-1,3-cyclobutanediol |
| HD | Hexanediol, 1,6-Hexanediol |
| MPD | 2-methyl-1,3-propanediol |
| TPA | Terephthalic acid |
| IPA | Isophthalic acid |
| PD | Polydispersity |
| Ga | Gallium |
| Li | Lithium |
| Al | Aluminum |
| Zr | Zirconium |

### Example 1—Preparation of the Copolyesters

The process for the preparation of the copolyesters in the Examples shown herein is exemplified by the preparation of a copolyester having a target composition of 15 mole % terephthalic acid residues, 85 mole % isophthalic acid residues, 40 mole % 2,2,4,4-tetramethyl-1,3-cyclobutanediol residues, 40 mole % 1,4-cyclohexanedimethanol residues, and 20 mole % 1,6-hexanediol residues. (Polyester A)

Full polymer synthesis of Polyester A was performed using a polymer rig. Oligomer which was previously prepared using charges in Table 1 was utilized when fully polymer synthesis was not necessary. The oligomer composition contained 15 mole percent TPA and 85 mole percent IPA. The glycol concentrations of the oligomer were as follows: 40 mole percent TMCD, 40 mole percent CHDM and 20 mole percent HDO. The overall charge mole ratio 1.145. Experiments that utilized oligomer used 130 grams of material with an acid number of approximately 22 mg KOH/g polymer.

TABLE 1
Typical monomer charges for Polyester A synthesis.

| Reagent | Excess | Target grams |
|---|---|---|
| IPA | 1 | 70.6 |
| TPA | 1 | 13.3 |
| CHDM | 1.075 | 31.0 |
| TMCD | 1.25 | 36.1 |
| HDO | 1.075 | 12.7 |

Each experiment was conducted by adding the necessary materials to a 500 ml round bottom flask. For up front catalyst addition experiments the desired catalyst was added to the flask at this time. A stainless steel stir rod was inserted into the flask and fitted with a glass polymer head. A piece of Teflon tubing and vacuum hose was fitted over the stir shaft and polymer head to provide a sufficient seal during the vacuum stages of the reaction. The round bottom setup was clamped to the polymer rig and a glass side arm was attached to the polymer head. A receiving flask was placed on the other end of the side arm and connected to a vacuum pump through the hose connection. The receiving flask was cooled with dry ice. A Belmont metal bath was used to heat the reaction mixture. All polymers were removed from the stir blade and ground to a particle size that would allow the material to pass through a screen perforated with 6 mm holes. All testing was performed on the granules without further processing.

TABLE 2
Camile Sequence used for synthesis of Polyester A.

| | Time | Temperature | Vacuum | Stir |
|---|---|---|---|---|
| Stage | (min) | (° C.) | (torr) | (rpm) |
| 1 | 0.5 | 220 | 730 | 0 |
| 2 | 5 | 220 | 730 | 50 |
| 3 | 15 | 220 | 730 | 150 |
| 4 | 1 | 220 | 730 | 200 |
| 5 | 60 | 230 | 730 | 200 |
| 6 | 40 | 240 | 730 | 200 |
| 7 | 60 or 120 | 240 | 730 | 200 |
| 8 | 10 | 240 | 250 | 200 |
| 9 | 10 | 240 | 1 | 100 |
| 10 | 60, 120, 210 | 240 | 1 | 100 |
| | or 270 | | | |
| 11 | 0.5 | 250 | 730 | 0 |

TABLE 3
Polyester A specifications.

| Composition | Mn | AN | OHN | b* |
|---|---|---|---|---|
| Polyester A | 4500-5000 | 2.0-5.0 | 15-18 | <10 |

TABLE 4
Examples of Zirconium (Zr) acetylacetonate
catalyzed Polyester A and haze results.

| | Zr | Time of Zr | IV | | | |
|---|---|---|---|---|---|---|
| Example | ppm | addition | (dl/g) | AN | OHN | Haze |
| 4A | 222 | Start | 0.26 | 2.2 | 14.3 | Yes |
| 4B | 285 | At low | 0.26 | 3.4 | 13.1 | No |
| | | AN ~25 | | | | |

TABLE 5
Examples of Lithium (Li) acetylacetonate and Aluminum
(Al) acetylacetonate catalyzed Polyester A and haze results.

| Example | Li | Al | Time of | IV | | | |
|---|---|---|---|---|---|---|---|
| # | ppm | ppm | addition | (dl/g) | AN | OHN | Haze |
| 5A | 79 | 121 | Start | 0.24 | 4.2 | 20.3 | Yes |
| 5B | 79 | 246 | Start | 0.22 | 5.3 | 23.8 | Yes |
| 5C | 106 | 131 | Stage 7 | 0.41 | 1.4 | 8.0 | No |
| | | | before | | | | |
| | | | vacuum | | | | |
| 5D | 61 | 22 | Stage 7 | 0.22 | 3.7 | 23.2 | No |
| | | | before | | | | |
| | | | vacuum | | | | |

TABLE 6
Examples Gallium (Ga) acetylacetonate
catalyzed Polyester A and haze results.

| Example | Ga | Time of | IV | | | |
|---|---|---|---|---|---|---|
| # | ppm | addition | (dl/g) | AN | OHN | Haze |
| 6A | 329 | Start | 0.22 | 6.7 | 19.7 | Yes |
| 6B | 287 | Before | 0.26 | 6.7 | 14 | No |
| | | Vacuum | | | | |

TABLE 7
Polyesters B-G—Compositional Data.

| | | | | Cis- | Trans- | | | |
|---|---|---|---|---|---|---|---|---|
| | MPD | | TMCD | TMCD | TMCD | IPA | TPA | Cis/ |
| Poly- | (Mole | CHDM | (Mole | (Mole | (Mole | (Mole | (Mole | Trans |
| ester | %) | (Mole) | %) | %) | %) | %) | %) | Ratio |
| B | 18.6 | 44.9 | 36.5 | 61.3 | 38.7 | 84.9 | 15.1 | 1.6 |
| C | 19.5 | 43.9 | 36.6 | 61.3 | 38.8 | 85.1 | 14.9 | 1.6 |
| D | 18.7 | 42.1 | 39.1 | 61.5 | 38.5 | 85.1 | 14.9 | 1.6 |
| E | 19.2 | 44.0 | 36.8 | 61.7 | 38.3 | 84.6 | 15.4 | 1.6 |
| F | 19.1 | 42.8 | 38.2 | 61.7 | 38.3 | 84.8 | 15.3 | 1.6 |
| G | 18.0 | 41.9 | 40.1 | 61.7 | 38.3 | 85.1 | 14.9 | 1.6 |

The processing conditions for making Polyesters B-F are substantially similar to those described for Polyester A herein except as described in Table 8.

TABLE 8
Processing Conditions for Polyesters B-F.

| | | Catalyst |
|---|---|---|
| Polyester | Catalyst Type | (ppm) |
| B | Ga acetylacetonate | 32 |
| C | Ga acetylacetonate | 60 |
| D | Zr Butoxide | 26 |
| E | Zr Butoxide | 92 |
| F | Li acetylacetonate/ | 34/7 |
| | Al acetylacetonate | |

TABLE 9
Properties of Polyesters B-F

| Poly- | | | | | IV | | |
|---|---|---|---|---|---|---|---|
| ester | Mn | Mw | Mz | PD | (dl/g) | AN | OHN |
| B | 3288 | 5758 | 8152 | 1.751 | 0.225 | 6.6 | 27.8 |
| C | 4127 | 7276 | 10197 | 1.763 | 0.266 | 5.8 | 19.5 |
| D | 2995 | 5395 | 7892 | 1.801 | 0.215 | 10.2 | 26.8 |
| E | 3969 | 6915 | 9752 | 1.742 | 0.256 | 4.6 | 21.7 |
| F | 3518 | 6329 | 9428 | 1.799 | 0.241 | 6.2 | 25.7 |

This disclosure has been described in detail with particular reference to preferred embodiments thereof, but it will be understood that variations and modifications can be effected within the spirit and scope of the disclosure.

1. A polyester composition comprising:
(1) at least one polyester which comprises:
(a) a dicarboxylic acid component comprising:
(i) about 0.01 to about 50 mole % residues of terephthalic acid or esters thereof;
(ii) about 50 to about 99.99 mole % residues of isophthalic acid or esters thereof;
(ii) about 0 to about 30 mole % of modifying aromatic or aliphatic dicarboxylic acid residues, or combinations thereof, having up to 20 carbon atoms;
(b) a glycol component comprising:
(i) about 25 to about 65 mole % of 1,4-cyclohexanedimethanol residues;
(ii) about 0 to about 35 mole % of hexanediol residues; and
(iii) about 0 to about 75 mole % of modifying glycol residues;
wherein the total mole % of the dicarboxylic acid component is 100 mole %,
wherein the total mole % of the glycol component is 100 mole %; and
(2) residues of a catalyst system comprising: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

2. The polyester composition of claim 1 wherein said modifying glycols comprise at least one of 2,2,4,4-tetramethyl-1,3-cyclobutanediol, diethylene glycol, 1,2-propanediol, 1,3-propanediol, 2-methyl-1,3-propanediol, ethylene glycol, 1,4-butanediol, 1,5-pentanediol, p-xylene glycol, neopentyl glycol, isosorbide, polytetramethylene glycol, or combinations thereof.

3. The polyester composition of claim 1 wherein said modifying glycols comprise 2,2,4,4-tetramethyl-1,3-cyclobutanediol, 2-methyl-1,3-propanediol, or combinations thereof.

4. The polyester composition of claim 1, wherein the glycol component further comprises residues of 2,2,4,4-tetramethyl-1,3-cyclobutanediol in the amount of from about 5 to about 79.99 mole %.

5. The polyester composition of claim 1 wherein the at least one polyester has a number average molecular weight is from 2000 to 8000.

6. The polyester composition of claim 1, wherein the at least one polyester has a b* value of from −10 to less than 20, as determined by the L*a*b* color system of the CIE (International Commission on Illumination).

7. The polyester composition of claim 1, wherein the at least one polyester has a final acid number of up to 10 mg KOH/g of polymer.

8. The polyester composition of claim 1 wherein the at least one polyester has a final hydroxyl number of up to 40 mg KOH/g of polymer.

9. A polyester composition comprising:
(1) at least one polyester which comprises:
(a) a dicarboxylic acid component comprising:
(i) about 0.01 to about 50 mole % residues of terephthalic acid or esters thereof;
(ii) about 50 to about 99.99 mole % residues of isophthalic acid or esters thereof;
(ii) about 0 to about 30 mole % of aromatic or aliphatic dicarboxylic acid residues, or combinations thereof, having up to 20 carbon atoms;
(b) a glycol component comprising:
(i) about 20 to about 65 mole % of 2,2,4,4-tetramethyl-1,3-cyclobutanediol residues;
(ii) about 0 to about 35 mole % of hexanediol residues; and
(iii) about 0 to about 80 mole % of modifying glycol residues;
wherein the total mole % of the dicarboxylic acid component is 100 mole %,
wherein the total mole % of the glycol component is 100 mole %; and
(2) residues of a catalyst system comprising: (a) lithium atoms and aluminum atoms, (b) gallium atoms, or (c) zirconium atoms, and (d) optionally, less than 30 ppm, or less than 20 ppm, or less than 10 ppm, or less than 5 ppm, or from 0 to 30 ppm, or from 0 to 20 ppm, or from 0 to 10 ppm, or 0 ppm of tin atoms, relative to the mass of final polyester being prepared.

10. The polyester composition of claim 9, wherein said modifying glycols comprise at least one of ethylene glycol, 1,4-cyclohexanedimethanol, diethylene glycol, 1,2-propanediol, 1,3-propanediol, 1,4-butanediol, 2-methyl-1,3-propanediol, 1,5-pentanediol, 1,6-hexanediol, p-xylene glycol, neopentyl glycol, isosorbide, polytetramethylene glycol, or mixtures thereof.

11. A process for making the polyester or polyester composition of claim 1, the process comprising adding an esterification catalyst(s) after a start of an esterification process and prior to pulling vacuum during the esterification process.

12. The process of claim 11, wherein the esterification catalyst(s) is at least one zirconium catalyst, or at least one gallium catalyst, or at least one lithium/aluminum catalyst.

13. The process of claim 12 wherein at least one zirconium catalyst, or at least one gallium catalyst, or at least one lithium/aluminum catalyst is added from 0 to 40 minutes prior to pulling vacuum during the esterification process.

14. The process of claim 12 wherein at least one zirconium catalyst, or at least one gallium catalyst, or at least one lithium/aluminum is added to the esterification process when the polyol has an acid number of from 10 to 30 mg KOH/g polymer.

15. A coating composition comprising the polyester composition of claim 1.
